(19) United States
(12) Patent Application Publication
(10) Pub. No.: US 2011/0122739 A1
(43) Pub. Date: May 26, 2011

(54) Library control device and library system

(75) Inventors: Hideyuki Ueda, Kato (JP); Masakazu Fujiwara, Kato (JP)

(73) Assignee: FUJITSU LIMITED, Kawasaki (JP)

(21) Appl. No.: 12/926,109

(22) Filed: Oct. 26, 2010

(30) Foreign Application Priority Data
Nov. 25, 2009 (JP) 2009-267694

(51) Int. Cl. G11B 21/08

(52) U.S. Cl. 369/30.01; G9B/21.012

(57) ABSTRACT

A library control device to controls a library device includes a designated-information acquisition section, a loading control section, a transfer control section and a medium storage control section. The transfer control section that orders, when a storage location indicated by the loading control section to a library device and a storage location designated by storage-location designating information are different from each other, the library device to transfer a storage medium from the storage location designated by the storage-location designating information to a storage location different from the storage location designated by the storage-location designating information. The medium storage control section orders, when the storage medium designated by the medium-designating information is loaded in a drive and the storage medium is transferred to a storage shelf, the library device to store the storage medium in the storage location designated by the storage-location designating information by the transfer mechanism.

### CROSS-REFERENCE TO RELATED APPLICATION

This application is based upon and claims the benefit of priority of the prior Japanese Patent Application No. 2009-267694, filed on Nov. 25, 2009, the entire contents of which are incorporated herein by reference.

### FIELD

The embodiments discussed herein are related to a library control device controlling a library device, and a library system including the library control device and the library device.

### BACKGROUND

Conventionally, as a backup device for a large amount of information used in an information processing apparatus such as a computer system and a workstation, there is used a library device in which storage media such as tape cartridges are stored (for example, Japanese Patent Laid-open Publication No. 09-167414, No. 11-353760 and No. 2001-189045)

Many of this type of library device are each provided with a storage shelf having storage locations where storage media are stored. The storage media are stored in the library device such that each storage medium is stored in each storage location. In such a library device, generally, in accordance with indication (command) of a storage location to the library device, the storage medium stored in such a storage location is designated.

As an old type of library device among the library devices, there is known a fixed access type that conforms to, an old command system in which storage locations are designated in a given order.

In a host device that employs the fixed access type of library device for backup, the old command system is used.

Meanwhile, recently, as a new type of library device among the library devices, there has been developed a library device of a random access type that conforms to a new command system in which an arbitrary storage location is designated.

There is a demand to replace the library device of the fixed access type used for backup in an information system, with the library device of the random access type newly developed.

On the other hand, as for the host device, there is a demand to maintain the old command system for a while, because introduction of the new command system is accompanied with a great increase in cost. Thus, in order to eliminate a difference in command system between the host device and the library device without increasing the cost, it is conceivable to provide, between these devices, a library control device having a function of converting the command system.

Incidentally, as for the storage medium in the library device, generally, the storage medium is not left as it is once stored in the library device, but rather, for example, plural medium series are replaced with one another according to the type of backup data. When storage media in one series are taken out of the library device and then returned to the library device, as a general rule, the storage media are returned in the same order as the order before the storage media are taken out.

When storage media in a certain series are returned to the library device, if the storage media are returned in an order different from the original order, there is a possibility that backup information may be overwritten or deleted unexpectedly. Besides, in the old command system, a designated sequence of storage locations is hard to change and thus, once such a change occurs, a user must return the order in which storage media are stored to the original order, which leads to a huge burden in operation of the library device.

### SUMMARY

According to an aspect of the invention, a library control device includes a designated-information acquisition section, a loading control section, a transfer control section and a medium storage control section.

The designated-information acquisition section acquires medium-designating information that designates a storage medium for access target in the library device and storage-location designating information that designates a transfer origin for transfer of a storage medium by the transfer mechanism.

The library device includes a transfer mechanism for transferring a storage medium to each of transfer locations including a storage locations of a storage shelf and a loading point of a drive.

The loading control section at least eventually indicates, to the library device, a storage location of a storage medium designated by the medium-designating information, to cause the storage medium designated by the medium-designating information to be loaded into the drive

Here, “at least eventually indicates a storage location of the storage medium” represents that an indication of a storage location includes, for example, the following indication way. One of indication methods indicates, after checking a storage location of a storage medium designated by some way, the storage location for it. Other one of the indication methods indicates separate storage locations next-to-next without checking a storage location of a storage medium designated, and continuously performs indicating until reaching a storage location of a target storage medium.

The transfer control section performs the following process, when the storage location indicated by the loading control section to the library device and a storage location designated by the storage-location designating information are different from each other. The transfer control section orders, while the drive accesses the storage medium designated by the medium-designating information, the library device to transfer a storage medium other than a storage medium designated by the medium-designating information by the transfer mechanism from the storage location designated by the storage-location designating information to a storage location different from the storage location designated by the storage-location designating information, thereby emptying the storage location designated by the storage-location designating information.

The medium storage control section that orders, when the storage medium designated by the medium-designating information is loaded in the drive and the storage medium is transferred to the storage shelf, the library device to store the storage medium by the transfer mechanism in the storage location designated by the storage-location designating information emptied by the transfer control section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates the library system of the comparative example;

FIG. 2 is a diagram that illustrates the first embodiment;

FIG. 3 is a diagram that illustrates the second embodiment;

FIGS. 4A and 4B are external perspective diagrams of the tape cartridge;

FIG. 5 is an external perspective diagram of the magnetic tape wound round the reel;

FIG. 6 is a hardware block diagram of the command conversion device;

FIG. 7 is a diagram that illustrates the variable table;

FIG. 8 is a functional block diagram that illustrates the command conversion device in FIG. 3 while focusing on the command conversion;

FIG. 9 is a flowchart that illustrates the LDSP processing of the second embodiment;

FIG. 10 is a flowchart that illustrates the swap processing of the second embodiment;

FIG. 11 is a flowchart that illustrates the UNLOAD processing of the second embodiment;

FIG. 12 is a diagram that illustrates a process up to the completion of the automatic correction of the interchange;

FIGS. 13A and 13B are diagrams that illustrate the memory contents including the variable table in the RAM of the command conversion device according to the third embodiment;

FIG. 14 is a functional block diagram that illustrates the command conversion device of the third embodiment;

FIG. 15 is a flowchart that illustrates the first half of the LDSP processing in the third embodiment;

FIG. 16 is a flowchart that illustrates the latter half of the LDSP processing;

FIG. 17 is a flowchart that illustrates the swap processing of the third embodiment;

FIG. 18 is a flowchart that illustrates the UNLOAD processing of the third embodiment;

FIG. 19 is a diagram that illustrates the first one-third of the process up to completion of the automatic correction of the interchange;

FIG. 20 is a diagram that illustrates the next one-third of this process following what is illustrated in FIG. 19;

FIG. 21 is a diagram that illustrates the last one-third of this process;

FIGS. 22A and 22B are diagrams that illustrate the memory contents including the variable table in the RAM of the command conversion device according to the fourth embodiment;

FIG. 23 is a functional block diagram that illustrates the library system of the fourth embodiment;

FIG. 24 is an external perspective diagram of the tape cartridge in the fourth embodiment;

FIG. 25 is a flowchart that illustrates the initial setting processing in the fourth embodiment;

FIG. 26 is a flowchart that illustrates the LDSP processing in the fourth embodiment;

FIG. 27 is a flowchart that illustrates the swap processing in the fourth embodiment;

FIG. 28 is a flowchart that illustrates the UNLOAD processing in the fourth embodiment;

FIG. 29 is a diagram that illustrates the first half of the process up to the completion of the automatic correction of the interchange; and

FIG. 30 is a diagram that illustrates the latter half of this process.

### DESCRIPTION OF EMBODIMENTS

Before description of specific embodiments, there will be described at first a library system of a comparative example to be compared with the specific embodiments.

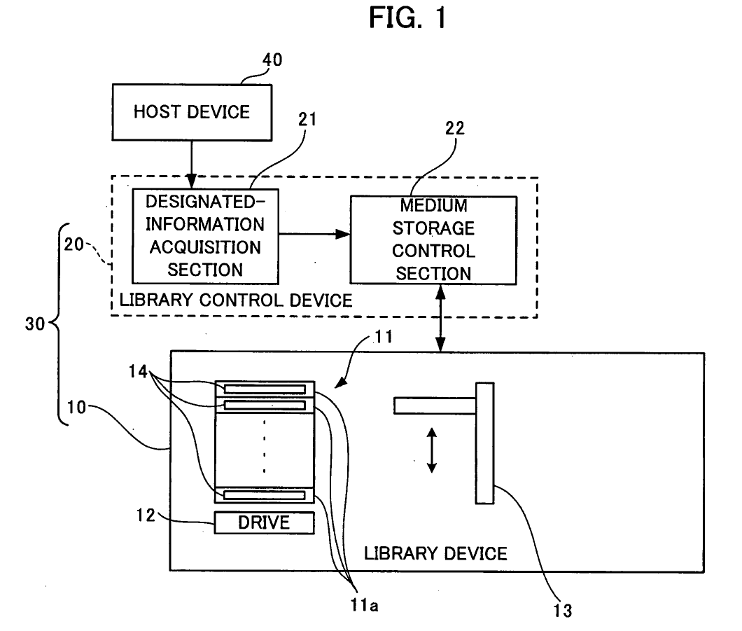

FIG. 1 is a diagram that illustrates the library system of the comparative example.

In FIG. 1, a library system 30 that includes a library device 10 and a library control device 20 is illustrated in the comparative example. Further, FIG. 1 illustrates a host device 40 that uses the library system 30 of this comparative example, for backup of processed information.

The library device 10 includes a storage shelf 11, a drive 12 and a transfer mechanism 13 as described below.

The storage shelf 11 includes plural storage locations 11a where storage media 14 are stored. Further, the storage locations 11a are given a series of serial numbers in ascending order from the uppermost storage location 11a to lower storage locations in FIG. 1. Furthermore, the storage media 14a are given a series of volume numbers. In this comparative example, there is adopted such a storage rule that the storage medium 14 is stored in the storage location 11a whose number agrees with the volume number of the storage medium 14. In other words, the storage medium with the volume number 1 is stored in the storage location with the number 1, and the storage medium with the volume number 2 is stored in the storage location with the number 2.

The drive 12 is loaded with the storage medium 14 and accesses the loaded storage medium 14. The transfer mechanism 13 transfers the storage medium 14 to each of transfer locations including the storage locations 11a of the storage shelf 11 and a loading point of the drive 12.

Here, this library device 10 is a random access type of library device that conforms to the following new command system. In this new command system, each of locations including plural storage locations 11a and the drive 12 may be designated freely as an origin of transfer of the storage medium 14. Further, such each of locations may be also designated freely as a destination of the transfer of the storage medium 14. In other words, according to this command system, transfer between an arbitrary storage location 11a and the drive 12 and transfer between arbitrary plural storage locations 11a may be designated.

Meanwhile, a command system in a host device 40 is the following old command system. In this old command system, as for transfer of the storage medium 14, only taking the storage medium 14 out of the storage location 11a and loading the storage medium to the drive 12, and taking the storage medium 14 out of the drive 12 and returning the storage medium 14 to the original storage location 11a may be designated. Further, in this old command system, when the storage medium 14 is loaded into the drive 12, plural storage locations 11a are designated in ascending order of the series of serial numbers as the origin of the transfer of the storage medium 14.

Therefore, in this comparative example, in order to eliminate a difference in command system between the host device 40 and the library device 10, the library control device 20 having a function of converting the command system is provided between these devices.

The library control device 20 includes a designated-information acquisition section 21 and the medium storage control section 22.

The designated-information acquisition section 21 receives a command for fixed access type from the host device 40.

The medium storage control section 22 converts the command for fixed access type acquired by the designated information acquisition region 21 into a command for random access type, and then issues the command for random access type to the library device 10.

In this library system 30 of the comparative example, at the time of backup, the storage locations 11a are designated in numerical order as described above by the command for fixed access type issued by the host device 40. Based on the series of serial numbers, the medium storage control section 22 finds which one of the plural storage locations 11a is the storage location 11a designated by the command for fixed access type. Subsequently, the medium storage control section 22 informs, through the command for random access type, the library device 10 of the found storage location 11a. Further, the medium storage control section 22 also orders, through a command, the transfer of the storage medium 14 from the informed storage location 11 to the drive 12, and reading and writing of information from and into the storage medium 14. In the library device 10, upon receipt of such a command from the medium storage control section 22, the storage medium 14 of the storage location 11a designated by the command is taken out and loaded into the drive 12 by the transfer mechanism 13. Subsequently, the storage medium 14 is driven by the drive 12, and reading and writing of information from and into the storage medium 14 is performed.

As mentioned earlier, in this comparative example, there is adopted such a storage rule that the storage medium 14 is stored in the storage location 11a whose number agrees with the volume number of the storage medium 14. Therefore, in this comparative example, the storage media 14 are accessed in ascending order of volume number, by the command for fixed access type from the host device 40.

In this library system 30 of the comparative example, suppose, for instance, there occurs an “interchange” in which the storage medium 14 with the volume number 3 is stored in the storage location 11a of the number 1, against the storage rule. Even when such an interchange occurs in the library device 10, the host device 40 designates the storage locations 11a according to a predetermined order as described above. For this reason, in this comparative example, when the storage location 11a with the number 1 is designated based on the storage rule, the storage medium 14 with the volume number 3, instead of the storage medium 14 of the volume number 1, is accessed. Such access may result in unexpected overwriting of backup data stored in the storage medium 14 with the volume number 3. Also, there is a case in which although reading of backup data from the storage medium 14 with the volume number 1 is intended, another backup data stored in the storage medium 14 with the volume number 3 is read instead. When a user finds such an interchange, the user puts the storage medium 14 back according to the designated sequence of the storage locations 11a on the host device 40 side, which leads to a huge burden in operation of the library device 10.

In contrast to the comparative example described above, when an interchange of storage media takes place in the specific embodiments that will be described below, the interchange is automatically corrected.

At first, a first embodiment will be described.

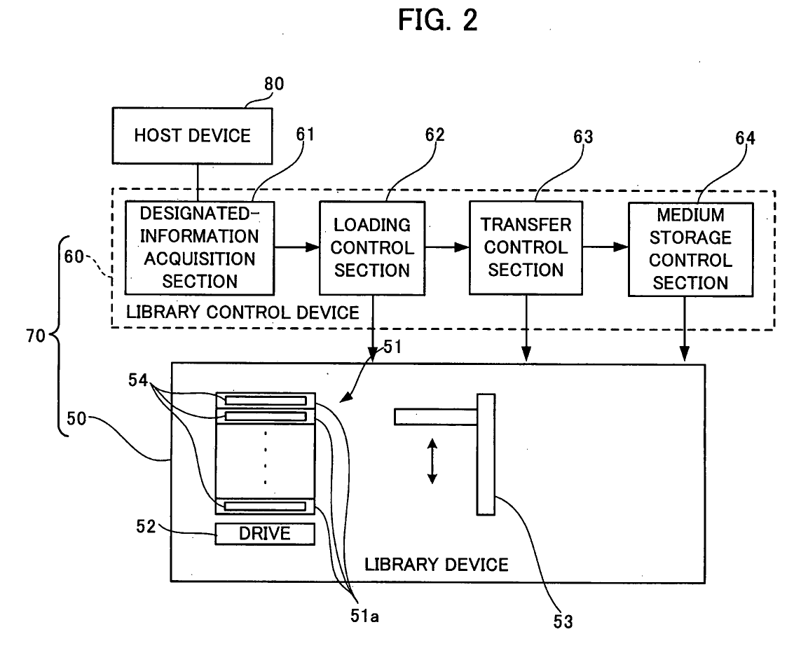

FIG. 2 is a diagram that illustrates the first embodiment.

FIG. 2 illustrates a library system 70 that includes a library device 50 and a library control device 60. FIG. 2 also illustrates a host device 80 that uses the library system 70 for backup of processed information.

In the present embodiment, the library control device 60 in FIG. 2 is equivalent to a specific embodiment of the library control device according to the basic aspect described above. Further, in the present embodiment, the library device 50 in FIG. 2 is equivalent to an example of the library device according to the basic aspect described above.

The library device 50 includes a storage shelf 51, a drive 52 and a transfer mechanism 53 as described below. The storage shelf 51 includes plural storage locations 51a in which storage media 54 are stored. The drive 52 are loaded with the storage medium 54 to access the storage medium 54. The transfer mechanism 53 transfers the storage medium 54 to each of transfer locations including the storage locations 51a of the storage shelf 51 and a loading point of the drive 52.

The library control apparatus 60 includes a designated-information acquisition section 61, a loading control section 62, a transfer control section 63 and a medium storage control section 64.

The designated-information acquisition section 61 acquires medium-designating information that designates a storage medium 54 targeted for access in the library device 50, and storage-location designating information that designates an origin of transfer of the storage medium 54 by the transfer mechanism 53.

The loading control section 62 at least eventually indicates the storage location 51a of the storage medium 54 designated by the medium-designating information to the library device 50, thereby causing loading of the storage medium 54 designated by the medium-designating information into the drive 52.

Here, although the way of at least eventually indicating the designated storage location 51a of the storage medium 54 is not specified in the present embodiment, there are some ways as follows. One way is to indicate, after checking the designated storage location 51a of the storage medium 54 by some way, that storage location 51a; and another way is to keep designating storage locations 51a one after another without checking the designated storage location 51a of the storage location 51a, until reaching the target storage location 51a of the storage medium 54.

When the storage location 51a indicated to the library device 50 by the loading control section 62 and the storage location 51a designated by the storage-location designating information are different from each other, the following processing is performed. In this case, while the drive 52 accesses the storage medium 54 designated by the medium-designating information, the transfer control section 63 gives an order to the library device 50 as follows. The transfer control section 63 orders transfer of the storage medium 54 by the transfer mechanism 53, from the storage location 51a designated by the storage-location designating information to the storage location 51a different from the designated storage location 51a.

When the storage medium 54 designated by the medium-designating information is loaded into the drive 52 and the storage medium 54 is to be transferred to the storage shelf 51, the medium storage control section 64 instructs the library device 50 as follows. In this case, the medium storage control section 64 orders storage of the storage medium 54 by the transfer mechanism 53 to the storage location 51a designated by the storage-location designating information.

In the present embodiment, the loading control section 62 indicates the storage location 51a of the storage medium 54 designated by the medium-designating information to the library device 50. Subsequently, the storage medium 54 in the storage location 51a is loaded into the drive 52 according to this indication of the storage location 51a. The storage medium 54 thus loaded into the drive 52 is the storage medium 54 targeted for access. When the storage location 51a indicated by the loading control section 62 to load this storage medium 54 targeted for access is different from the storage location 51a designated by the storage-location designating information, the storage medium 54 targeted for access is interchanged with other one. The storage location 51a designated by the storage-location designating information is the correct storage location 51a in which the storage medium 54 targeted for access is to be stored. When an interchange occurs, in the present embodiment, the correct storage location 51a is emptied by order of the transfer control section 63, in the middle of access to the storage medium 54 targeted for access. Subsequently, in the correct storage location 51a thus emptied, the storage medium 54 targeted for access is stored by order of the medium storage control section 64. In other words, in the present embodiment, when there is an interchange, the storage location 51a of the storage medium 54 is emptied by using the time during which the storage medium 54 is accessed. Subsequently, upon completion of the access, the storage medium 54 targeted for access is stored in the correct storage location 51a. As a result, in the present embodiment, an interchange of the storage medium 54 targeted for access is automatically corrected.

Next, a second embodiment will be described.

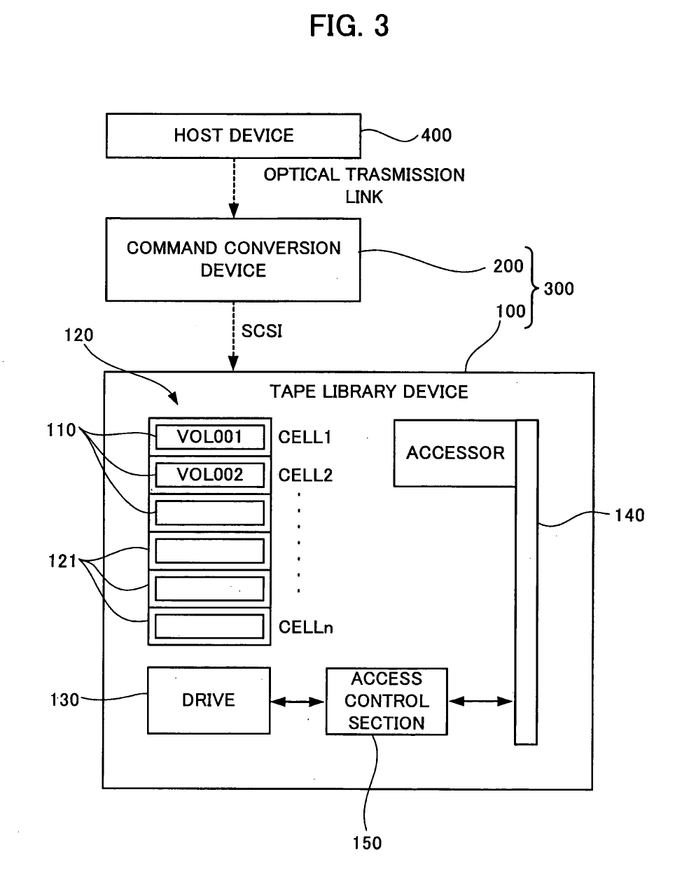

FIG. 3 is a diagram that illustrates the second embodiment.

FIG. 3 illustrates a library system 300 that includes a tape library device 100 that uses tape cartridges 110 each housing an electromagnetic tape as storage media. Further, FIG. 3 also illustrates a host device 400 that uses the library system 300 for backup of process information. The library system 300 in FIG. 3 includes a command conversion device 200 that converts a command signal sent from the host device 400 into a command signal adapted to the tape library device 100.

In the present embodiment, the command conversion device 200 in FIG. 3 is equivalent to a specific embodiment of the library control device according to the basic aspect described above. Further, in the present embodiment, the tape library device 100 in FIG. 3 is equivalent to an example of the library device according to the basic aspect described above.

In the present embodiment, the host device 400 is connected to the command conversion device 200 by an optical transmission link that uses optical fiber. The command conversion device 200 is connected to the tape library device 100 by a Small Computer System Interface (SCSI).

First, the tape library device 100 will be described.

The tape library device 100 stores plural tape cartridges 110 to which volume numbers, namely, a series of serial numbers, are assigned. In the present embodiment, this tape cartridge 110 is equivalent to an example of the storage medium according to the basic aspect described above. In the present embodiment, the volume number is stored magnetically on a magnetic tape within the tape cartridge 110 having the volume number.

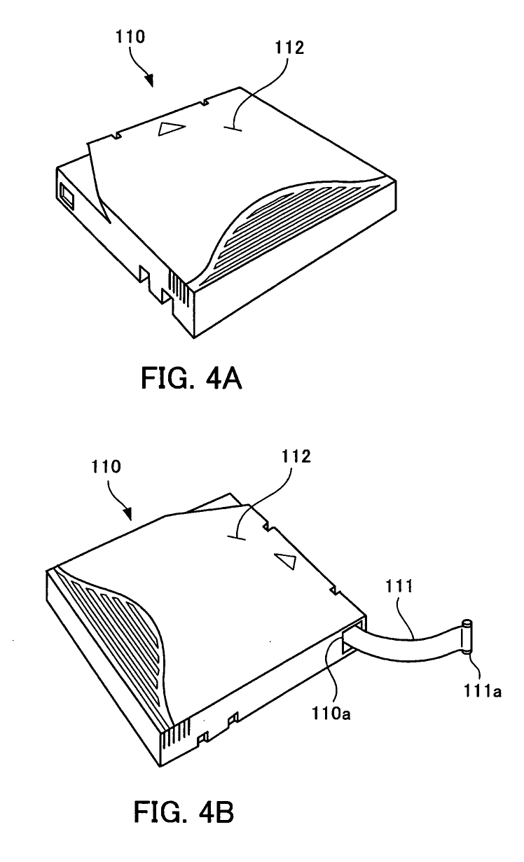

FIGS. 4A and 4B are external perspective diagrams of the tape cartridge.

FIG. 4A is a perspective diagram of the tape cartridge 110 with an output port 110a, which will be described later, being directed rearward in FIG. 4A. FIG. 4B is a perspective diagram of the tape cartridge 110 with the output port 110a being directed frontward in FIG. 4B.

This tape cartridge 110 includes a flat rectangular shell 112. A magnetic tape 111 that will be described later is housed in this shell 112. In appearance, as illustrated in FIG. 4B, the output port 110a of the magnetic tape 111 is provided on a flank of the shell 112. When information is read or written, the magnetic tape 111 is drawn out from the output port 110a.

Inside this shell 112, the magnetic tape 111 is housed in a state of being wound around a reel as described below.

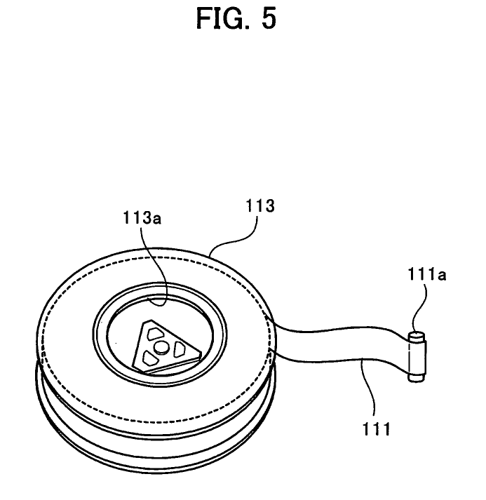

FIG. 5 is an external perspective diagram of the magnetic tape wound round the reel.

As illustrated in FIG. 5, the magnetic tape 111 is wound around a reel 113 having a cylindrical central shaft 113a. To a tip of the magnetic tape 111, a leader pin 111a is attached to serve as a hook so that the magnetic tape 111 is drawn outside of the shell 112 from the output port 110a illustrated in FIG. 4B.

In the present embodiment, the volume number of the tape cartridge 110 is stored in an area on the tip side near the leader pin 111a, in the magnetic tape 111.

In the tape library device 100 in FIG. 3, the magazine 120 having plural cells 121 to which cell numbers, namely a series of serial numbers, are assigned is removably housed. Further, in the magazine 120, these plural cells 121 are aligned in order of cell number.

Each of the tape cartridges 110 is stored in each of the cells 121 of the magazine 120. When the magazine 120 is stored in the tape library device 100, the plural tape cartridges 110 are stored in the tape library device 100. In the present embodiment, the magazine 120 is equivalent to an example of the storage shelf according to the basic aspect described above. Each of the cells 121 of the magazine 120 is equivalent to an example of the storage location according to the basic aspect described above.

On the host device 400 side, a storage position of each of the tape cartridges 110 in the tape library device 100 is determined. In the following description, as an example, suppose it is determined that the tape cartridge 110 is to be stored in the cell 121 of the cell number matching the volume number. Specifically, the tape cartridge 110 with the volume number “VOL001” is stored in the cell 121 with the number 1. Further, the tape cartridge 110 with the volume number “VOL002” is stored in the cell 121 with the number 2.

The tape library device 100 includes a tape drive 130, an accessor 140 and an access control section 150, which will be described later.

When one tape cartridge 110 is loaded into the tape drive 130, the tape drive 130 performs access such as writing and reading of information by driving the loaded tape cartridge 110. In the present embodiment, the tape drive 130 is equivalent to an example of the drive according to the basic aspect described above.

The accessor 140 is a transfer mechanism capable of transferring the tape cartridge 110 to each of transfer locations including the cells 121 of the magazine 120 and a loading point of the tape drive 130. In the present embodiment, the accessor 140 is equivalent to an example of the transfer mechanism according to the basic aspect described above.

Upon receipt of various types of command sent from the command conversion device 200, the access control section 150 controls operation of the accessor 140 and the tape drive 130.

Incidentally, the tape library device 100 in the present embodiment is a library device of random access type conforming to the new command system described above for the comparative example.

On the other hand, in the host device 400, a backup program and the like are implemented on the assumption that the tape library device of the fixed access type described above is used as a backup device. For this reason, the host device 400 issues, at the time of backup, a command for fixed access type such as LDSP, UNLOAD, READ and WRITE, which will be described later. Subsequently, the command conversion device 200 converts the command issued by the host device 400 into a command for random access type, and transmits the command for random access type to the tape library device 100 of the present embodiment. In the present embodiment, by a system configuration using this command conversion device 200, the tape library device 100 of the random access type is employed, while the command system of the fixed access type is maintained as a command system in the host device 400.

Further, in the present embodiment, the host device 400 issues the command as an optical signal through the optical transmission link. The command conversion device 200 also serves as interface conversion that converts the command in the form of optical signal into an electric signal adapted to the SCSI serving as a link to the tape library device 100.

The command issued by the host device 400 at the time of backup is any of four commands of LDSP, UNLOAD, READ and WRITE.

The LDSP is a command that designates the cell 121 following the cell 121 in which the tape cartridge 110 accessed previously is housed. As a result of the designation of the cell 121 by this LDSP, in the tape library device 100, the tape cartridge 110 from the designated cell 121 is loaded into the tape drive 130. However, when this command is issued for the first time after the magazine is set, there is no tape cartridge 110 accessed previously. Thus, when this command is issued for the first time after the magazine is set, this command is processed as a command that designates the top cell 121. In the present embodiment, this LDSP is equivalent to an example of the storage-location designating information according to the basic aspect described above.

Further, the volume number (the access volume number V1 that will be described later) of the tape cartridge 110 to be loaded into the tape drive 130 is attached to this LDSP in accordance with the rule of the original command system.

The UNLOAD is a command to return the tape cartridge 110 being loaded into the tape drive 130 to the original cell 121.

The READ is a command to read information from the tape cartridge 110.

The WRITE is a command to write information into the tape cartridge 110.

In the present embodiment, these four commands are issued from the host device 400 as appropriate, and thereby backup of information to the tape library device 100 and restoration of information from the tape library device 100 are executed.

Here, as described above, on the host device 400 side, it is determined that the tape cartridge 110 is to be stored in the cell 121 with the cell number matching the volume number. For this reason, the host device 400 performs issue of the LDSP and the like on the assumption that the tape cartridge 110 is to be stored according to this storage rule.

In other words, the host device 400 performs processing on the assumption that the tape cartridge 110 of “VOL001” is accessed at the time when the first LDSP is issued, and the tape cartridge 110 of “VOL002” is accessed at the time when the second LDSP is issued.

Here, suppose the tape cartridge 110 is stored in the cell 121 different from the cell 121 based on the storage rule, because of an interchange of the tape cartridges 110. At the time, when restoration and backup of information are executed without any correction, writing and reading of the information into and from the tape cartridge 110 different from the assumption are performed, as described above in the comparative example. In the present embodiment, correction of such an interchange is executed in the command conversion device 200, which will be described later in detail.

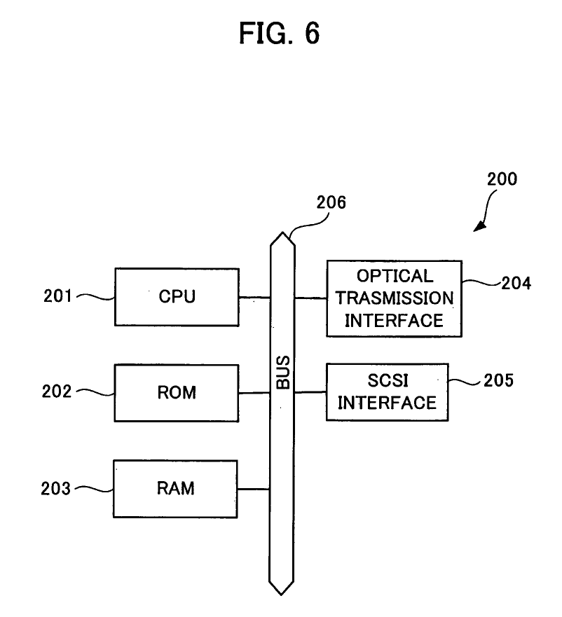

FIG. 6 is a hardware block diagram of the command conversion device.

In the command conversion device 200, there are executed an interface conversion program for performing interface conversion from the optical transmission link to the SCSI and a command conversion program for performing command conversion of a command such as the LDSP. The command conversion device 200 includes, as illustrated in FIG. 6, a CPU 201, a ROM 202, a RAM 203, an optical transmission interface 204 and a SCSI interface 205.

The CPU 201 executes the interface conversion program and the command conversion program. Further, in the ROM 202, these interface conversion program and command conversion program are stored. In the RAM 203, each program is expanded at the time of execution. In the present embodiment, various types of variable used when each program is executed are stored in this RAM 203.

Incidentally, the interface conversion is a well-known technique and thus will not be described.

In the present embodiment, various types of variable used at the time of executing the command conversion program are stored in the following variable table in the RAM 203.

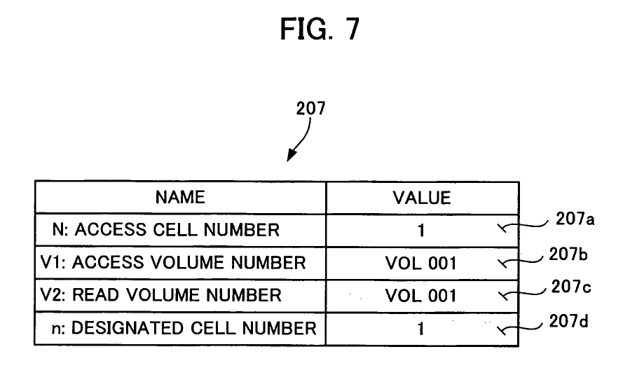

FIG. 7 is a diagram that illustrates the variable table.

As illustrated in FIG. 7, the variable table 207 includes a storage field 207a for an access cell number N, a storage field 207b for an access volume number V1, a storage field 207c for a read volume number V2, and a storage field 207d for a designated cell number n.

The access cell number N is a cell number designated by the command (LDSP) from the host device 400. In other words, the access cell number N is the cell number of the cell in which the tape cartridge targeted for access is expected to be stored.

The access volume number V1 is the volume number attached to the LDSP and indicated by the host device 400. The access volume number V1 is the volume number of the tape cartridge 110 targeted for access. In the present embodiment, the access volume number V1 is equivalent to an example of the medium-designating information according to the basic aspect described above.

The read volume number V2 is the volume number read from the tape cartridge 110 loaded into the tape drive 130. In the present embodiment, this read volume number V2 is equivalent to an example of the stored-medium information according to another aspect that will be described later.

The designated cell number n is the cell number actually indicated to the tape library device 100 by the command conversion device 200.

In each of the storage fields in the variable table 207, an initial value illustrated in FIG. 7 is stored at the time when the magazine 120 is loaded into the tape library device 100.

In the storage field 207a of the access cell number N, “1” that is the cell number of the top cell 121 in the magazine 120 is stored as the initial value. In the storage field 207d of the designated cell number n as well, the cell number “1” is stored as the initial value. In the storage field 207b of the access volume number V1, “VOL001” that is the volume number matching with the cell number “1” is stored as the initial value. In the storage field 207c of the read volume number V2 as well, the volume number “VOL001” is stored as the initial value.

This completes the description of the variable table 207 in FIG. 7, and the description of the embodiment will be continued by returning to FIG. 6.

The optical transmission interface 204 illustrated in FIG. 6 is used to connect the command conversion device 200 to the host device 400 illustrated in FIG. 3 through optical transmission. The SCSI interface 205 is used to connect the command conversion device 200 to the tape library device 100 illustrated in FIG. 3 through the SCSI.

The elements of the command conversion device 200 are interconnected via a bus 206.

The description of the command conversion device 200 will be continued as follows while focusing attention on the command conversion.

In the command conversion device 200, various functional blocks which will be described below are implemented through execution of the command conversion program in the ROM 202 by the CPU 201.

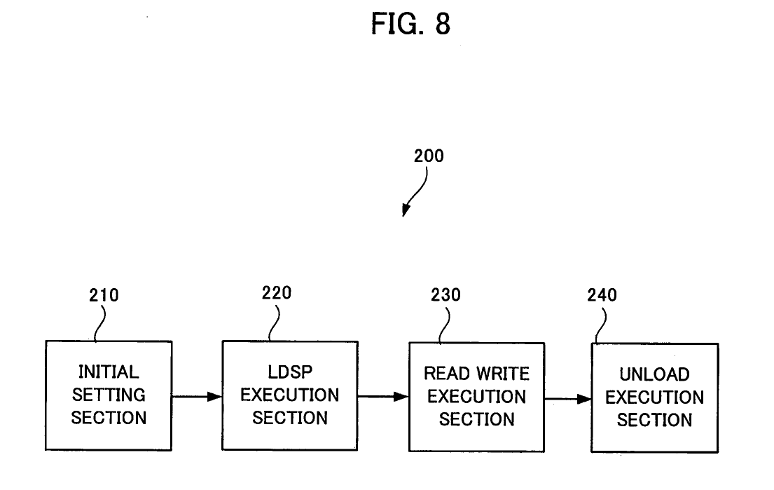

FIG. 8 is a functional block diagram that illustrates the command conversion device in FIG. 3 while focusing on the command conversion.

The command conversion device 200 includes an initial setting section 210, an LDSP execution section 220, a read write execution section 230 and an UNLOAD execution section 240.

Each element will be described below along a flow of backup processing executed in the library system 300 in FIG. 3.

In the backup processing, at first, the magazine 120 housing the plural tape cartridges 110 is stored in the tape library device 100 in FIG. 3. Subsequently, from the host device 400, the commands of LDSP, WRITE (or READ) and UNLOAD are issued sequentially, and information is written into (or read from) one cartridge tape. When writing (or reading) of information is performed for plural cartridge tapes, the above commands are repeatedly issued from the host device 400.

First, when the magazine 120 is stored in the tape library device 100, the tape library device 100 informs the command conversion device 200 of this effect. Then, the initial setting section 210 in FIG. 8 executes initial setting processing for storing each of the above-described initial values in the corresponding one of the storage fields in the variable table 207 in FIG. 7.

In the present embodiment, this initial setting processing is, so to speak, an interrupt service that is irrelevant to the issue of the various commands such as the LDSP in the host device 400 and executed in response to an event of storage of the magazine 120.

Next, the host device 400 issues the LDSP.

This LDSP is, as described above, a command to designate the cell 121 following the cell 121 in which the previously accessed tape cartridge 110 is stored, thereby causing loading of the tape cartridge 110 from the designated cell 121 into the tape drive 130.

Incidentally, as described above, the access volume number V1 is attached to this LDSP and this LDSP is issued from the host device 400.

When the LDSP is issued in this way, upon receipt of the LDSP, the LDSP execution section 220 in FIG. 8 executes the LDSP processing that will be described below.

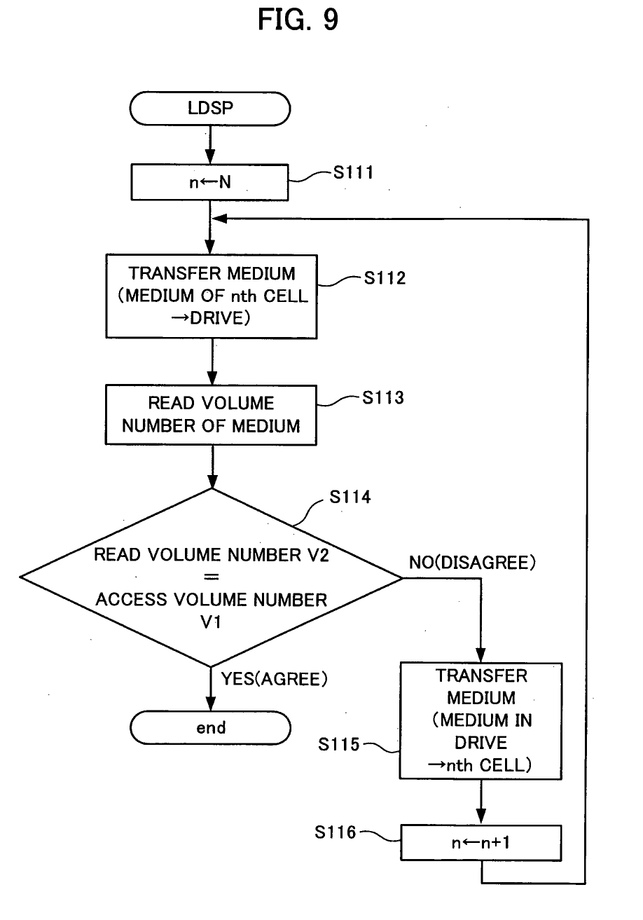

FIG. 9 is a flowchart that illustrates the LDSP processing of the second embodiment.

In this LDSP processing, first, whether the tape cartridge 110 in the cell 121 of the access cell number N is the tape cartridge 110 targeted for access is checked by a series of processes which will be described below.

At first, the access volume number V1 attached to the LDSP is written over the storage field 207b of the access volume number V1 in the variable table 207 in FIG. 5 by The LDSP execution section 220. Further, the access cell number N stored in the storage field 207a of the access cell number N is read by the LDSP execution section 220, and the access cell number N is written over the storage field 207d of the designated cell number n (step S111).

In the present embodiment, the LDSP execution section 220 is equivalent to an example of the designated-information acquisition section according to the basic aspect described above. Further, the processing in step S111 is equivalent to an example of the operation of the designated-information acquisition section according to the basic aspect described above.

Next, the LDSP execution section 220 in FIG. 8 reads the designated cell number n from the variable table 207. Subsequently, the LDSP execution section 220 issues a command that designates the cell 121 by using the designated cell number n, thereby causing loading of the tape cartridge 110 from the designated cell 121 into the tape drive 130 (step S112). The command issued in this step S112 is a command for random access type according to the tape library device 100 of the present embodiment.

Subsequently, the LDSP execution section 220 in FIG. 8 issues a command that orders reading of the volume number from the tape cartridge 110 loaded into the tape drive 130 (step S113). This order in the processing of step S113 also is performed by the command for random access type.

Further, in the processing of this step S113, the volume number (the read volume number V2) read according to the command is transmitted from the tape library device 100 to the command conversion device 200. Subsequently, the LDSP execution section 220 writes the transmitted read volume number V2 over the storage field 207c of the read volume number V2 in the variable table 207 in FIG. 7.

Next, the LDSP execution section 220 checks whether the read volume number V2 and the access volume number V1 stored in the variable table 207 in FIG. 7 agree with each other (step S114).

Here, what is compared with the access volume number V1 when this step S114 is executed in the flow from step S111 is the volume number of the tape cartridge 110 that has been stored in the cell 121 of the access cell number N described above. At the time, the two volume numbers V1 and V2 are expected to agree with each other, if there is no interchange of the tape cartridge 110 for the cell 121 of the access cell number N.

For this reason, when there is no interchange of the tape cartridge 110 and the two volume numbers V1 and V2 agree with each other (YES in step S114), this LDSP processing is completed and then, read write processing that will be described later is executed.

On the other hand, when the two volume numbers V1 and V2 do not agree with each other (NO in step S114), in this LDSP processing, a search for the tape cartridge 110 of the access volume number V1 is made as described below.

In this search, at first, the LDSP execution section 220 in FIG. 2 reads the designated cell number n from the variable table 207. Subsequently, the LDSP execution section 220 issues a command that designates the cell 121 with the read designated cell number n, thereby returning the tape cartridge 110 from the tape drive 130 to the designated cell 121 (step S115).

Next, the LDSP execution section 220 adds “1” to the designated cell number n read as described above, and writes the designated cell number n after the addition over the storage field 207d of the designated cell number n in the variable table 207 (step S116). Afterwards, the processing returns to step S112. Subsequently, by the processing from step S112 to S114, whether the read volume number V2 of the tape cartridge 110 in the cell 121 of the next cell number and the access volume number V1 agree with each other is checked.

Such processing from step S112 to S116 is repeated until the access volume number V1 and the read volume number V2 in the variable table 207 in FIG. 7 agree with each other. In the present embodiment, the tape cartridge 110 of the access volume number V1 is found from the plural tape cartridges 110 in the magazine 120 through such processing. Further, in the present embodiment, at the time when the tape cartridge 110 of this access volume number V1 is found, the tape cartridge 110 is in a state of being loaded into the tape drive 130. In other words, the designation of the cell 121 comes first and then, it is ensured that this designation is the designation of the cell 121 in which the tape cartridge 110 of the access volume number V1 is stored. Subsequently, when the tape cartridge 110 of the access volume number V1 is found, this LDSP processing is completed, and the read write processing that will be described later is executed.

In the present embodiment, the LDSP execution section 220 is equivalent to an example of the loading control section according to the basic aspect described above. Further, the processing from step S112 to S116 is equivalent to an example of the operation of the loading control section according to the basic aspect described above.

For the aspect of the invention, there is a preferable aspect as follows. In this preferable aspect, the loading control section includes a storage location indication section, a storage information acquisition section and a selection section. The storage location indication section indicates, to the library device, one storage location selected from among the plurality of storage locations, to cause the storage medium to be loaded from the designated storage location into the drive. The storage information acquisition section acquires stored-medium information representing the storage medium of the storage location indicated by the storage location indication section. The selection section repeats selection processing for selecting one storage location from among the plurality of storage locations so that the selected storage location is indicated to the library device by the storage location indication section, until the storage medium designated by the medium-designating information and the storage medium represented by the stored-medium information agree with each other, while changing the storage location.

According to this preferable aspect, by the above-described selection processing that is repeatedly executed, the storage location in which the storage medium designated by the medium-designating information is stored may be reliably indicated to the library device.

In the present embodiment, the LDSP execution section 220 is equivalent to an example of the storage location indication section according to this preferable aspect. Further, the processing in step S112 is equivalent to an example of the operation of the storage location indication section in this preferable aspect.

Furthermore, the LDSP execution section 220 is equivalent to an example of the storage information acquisition section in this preferable aspect. Moreover, the processing in step S113 is equivalent to an example of the operation of the storage information acquisition section in this preferable aspect.

Still furthermore, the LDSP execution section 220 is also equivalent to an example of the selection section in this preferable aspect. Moreover, the processing in step S114 through S116 is equivalent to an example of the operation of the selection section in this preferable aspect.

For the above-described preferable aspect in which the loading control section includes the storage location indication section, the storage information acquisition section and the selection section, there is a further preferable aspect as follows. In this preferable aspect, the storage medium includes a storage part where information is stored and a housing where the storage part is housed, and medium information for identifying the storage medium is stored in the storage part. The storage information acquisition section acquires the medium information stored in the storage part of the storage medium transferred to the drive by indication of the storage location in the storage location indication section, as the stored-medium information via the drive.

According to this preferable aspect, the stored-medium information may be readily obtained by reading the medium information via the drive.

In the present embodiment, the tape cartridge 110 is also equivalent to an example of the storage medium in this preferable aspect. Further, in the present embodiment, the magnetic tape 111 illustrated in FIG. 4 and FIG. 5 is equivalent to an example of the storage part in this preferable aspect. Furthermore, the shell 112 illustrated in FIG. 4 is equivalent to an example of the housing in this preferable aspect.

Moreover, in the present embodiment, the LDSP execution section 220 is also equivalent to an example of the storage information acquisition section in this preferable aspect. In addition, the processing of step S113 is also equivalent to an example of the operation of the storage information acquisition section in this preferable aspect.

In the LDSP processing described above, when the tape cartridge 110 targeted for access is found and loaded into the tape drive 130, the command conversion device 200 informs the host device 400 of this effect. Then, the host device 400 issues the READ or WRITE. Further, at the time of issuing the WRITE, the host device 400 also performs transmission of backup information subsequent to the issue of the command.

Upon receipt of these command and backup information, the read write execution section 230 (FIG. 8) of the command conversion device 200 executes the read write processing.

When the transmitted WRITE and backup information arrive, the read write execution section 230 issues a command that orders writing of the backup information into the loaded tape cartridge 110. Also, when the transmitted READ arrives, the read write execution section 230 issues a command that orders reading of the backup information from the loaded tape cartridge 110. Upon receipt of the backup information transmitted from the tape library device 100 according to this command, the read write execution section 230 transmits the backup information to the host device 400. The command in this read write processing also is the command for random access type.

Here, while the writing or reading of the backup information is performed by the tape drive 130, the read write execution section 230 executes swap processing that will be described below.

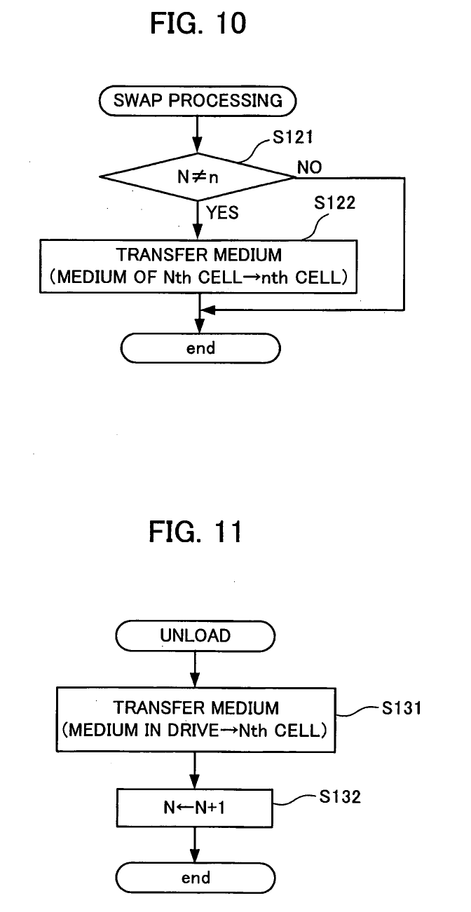

FIG. 10 is a flowchart that illustrates the swap processing of the second embodiment.

At first, the read write execution section 230 reads the access cell number N and the designated cell number n from the variable table 207 in FIG. 7 at the time of starting this swap processing, and determines whether these numbers are different from each other (step S121). This designated cell number n is the cell number of the cell 121 in which the tape cartridge 110 targeted for access loaded into the tape drive 130 is stored at this moment. In other words, in this step S121, it is determined whether the cell 121 in which the tape cartridge 110 targeted for access is actually stored is the cell 121 of the access cell number N.

When the access cell number N and the designated cell number n in the variable table 207 are different from each other (YES in step S121), processing in the next step S122 is executed, and this swap processing ends. On the other hand, when the access cell number N and the designated cell number n are equal to each other (NO in step S121), the processing of step S122 is omitted, and this swap processing ends.

In step S122, the read write execution section 230 issues the command that indicates the cell 121 of the transfer origin by using the access cell number N, and also indicates the cell 121 of the transfer destination by using the designated cell number n, so that the tape cartridge 110 is transferred from the transfer origin to the transfer destination. As a result, the cell 121 of the access cell number N in which the tape cartridge 110 currently being accessed is to be stored is emptied.

This read write execution section 230 is equivalent to an example of the transfer control section according to the basic aspect described above. Further, the processing in step S122 is equivalent to an example of the operation of the transfer control section according to the basic aspect described above.

Here, in the present embodiment, when the cell 121 in which the tape cartridge 110 targeted for access is to be stored is emptied, the cell 121 of the designated cell number n is used as follows. The cell 121 of the designated cell number n is used as the transfer destination of the tape cartridge 110 stored in the cell 121 of the access cell number N. The cell 121 of the designated cell number n is the cell 121 in which the tape cartridge 110 targeted for access has been actually stored. The cell 121 of the designated cell number n is vacant at present, because the tape cartridge 110 targeted for access is being accessed by the tape drive 130. In this way, the cell 121 in the magazine 120 is effectively utilized by using, as the transfer destination, the cell 121 in which the tape cartridge 110 targeted for access has been stored.

For the above-described aspect, there is a preferable aspect as follows. In this preferable aspect, the transfer control section orders transfer of the storage medium from the storage location designated by the storage-location designating information to the storage location in which the storage medium accessed by the drive has been stored.

The read write execution section 230 is equivalent to an example of the transfer control section in this preferable aspect. Further, the processing of step S122 is equivalent to an example of the operation of the transfer control section in this preferable aspect.

When the read write processing and the swap processing described above are completed, the command conversion device 200 informs the host device 400 of this effect. Then, the host device 400 issues the UNLOAD. Upon receipt of this UNLOAD, the UNLOAD execution section 240 of the command conversion device 200 executes UNLOAD processing.

FIG. 11 is a flowchart that illustrates the UNLOAD processing of the second embodiment.

In the UNLOAD processing, at first, the UNLOAD execution section 240 reads the access cell number N from the variable table 207 in FIG. 7.

Subsequently, the UNLOAD execution section 240 issues a command that indicates the cell 121 by using the access cell number N, thereby causing transfer of the tape cartridge 110 from the tape drive 130 to the designated cell 121 (step S131). The accessor 140 stores the tape cartridge 110 targeted for access in the cell 121 of the access cell number N in accordance with the command.

When the tape cartridge 110 targeted for access has been originally stored in the cell 121 of the access cell number N, this step S131 is merely a process of returning the tape cartridge 110 targeted for access to the original cell 121.

On the other hand, when the tape cartridge 110 targeted for access has been stored in the cell 121 different from the cell 121 of the access cell number N, this step S131 is a process of storing the tape cartridge 110 in the correct cell 121.

Upon completion of the processing in step S131, the UNLOAD execution section 240 adds “1” to the access cell number N read in step S131, and writes the access cell number N after the addition over the storage field 207a of the access cell number N (step S132). The UNLOAD execution section 240 finishes this UNLOAD processing upon completion of this overwriting.

The UNLOAD execution section 240 performing the UNLOAD processing described above is equivalent to an example of the medium storage control section according to the basic aspect described above.

Now, although slightly overlapping the description provided above with reference to FIG. 9 through FIG. 11, a process up to completion of automatic correction of the interchange in the present embodiment will be described by using a specific example of the interchange.

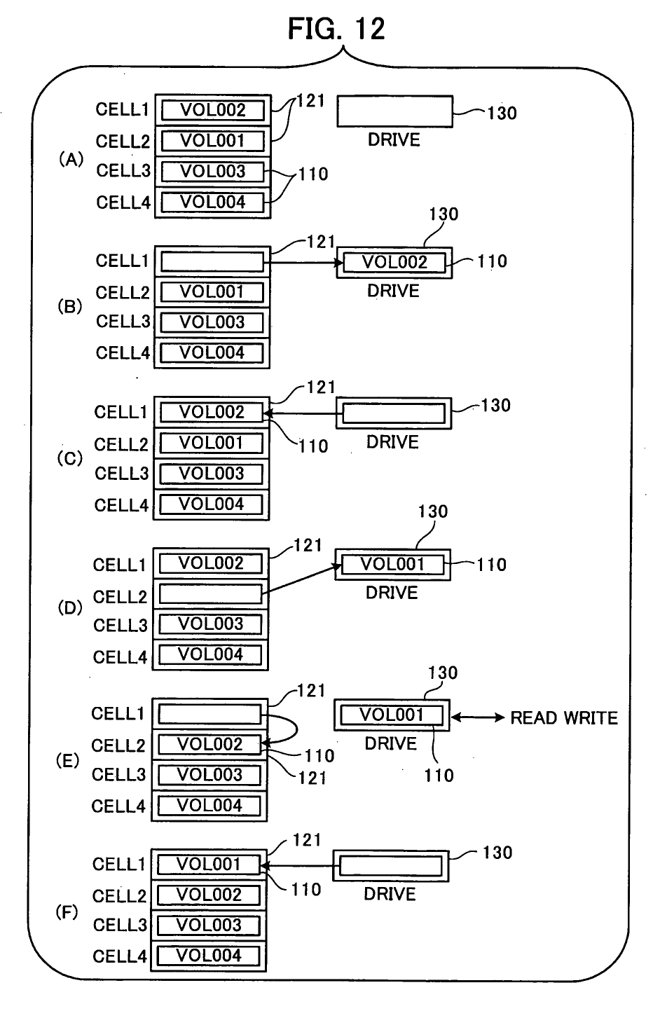

FIG. 12 is a diagram that illustrates a process up to the completion of the automatic correction of the interchange.

FIG. 12 illustrates a state in which interchanges are automatically corrected for four tape cartridges 110 having the volume numbers “VOL001” through “VOL004” stored in four cells 121 having the cell numbers “1” through “4”. Further, in the present embodiment, the correction of the interchange is executed every time access is made. For this reason, FIG. 12 also illustrates the tape drive 130 that accesses the tape cartridge 110.

At first, in the example in FIG. 12, as illustrated in Part (A), the tape cartridge 110 of “VOL001” and the tape cartridge 110 of “VOL002” are interchanged. In other words, the tape cartridge 110 of “VOL001” is desired to be stored in the cell 121 of the cell number “1”, but is stored in the cell 121 of the cell number “2”. Further, the tape cartridge 110 of “VOL002” is desired to be stored in the cell 121 of the cell number “2”, but is stored in the cell 121 of the cell number “1”.

In such a state, first, in response to issue of the first LDSP, the LDSP processing in FIG. 9 is executed. To the first LDSP, “VOL001” is attached as the access volume number V1.

Then, in the processing of step S112 in FIG. 9, as illustrated in Part (B) of FIG. 12, the tape cartridge 110 of “VOL002” is loaded from the cell 121 of the access cell number “1” into the tape drive 130. Subsequently, in the processing of step S113 and step S114 in FIG. 9, the volume number is read from this tape cartridge 110, and the read volume number and the access volume number V1 are compared with each other. In this example, the former is “VOL002” while the latter is “VOL001” and thus, it is determined that the read volume number and the access volume number V1 disagree with each other.

As a result, in the processing of step S115 in FIG. 9, as illustrated in Part (C) in FIG. 12, the tape cartridge 110 of “VOL002” loaded into the tape drive 130 is returned to the cell 121 of the original access cell number “1”.

Next, in the processing of step S116 and step S112 in FIG. 9, as illustrated in Part (D) in FIG. 12, the tape cartridge 110 is loaded from the cell 121 of the cell number “2”, instead of the access cell number “1”, into the tape drive 130. Subsequently, in a manner similar to the manner described above, the volume number “VOL001” of this tape cartridge 110 is read and compared with the access volume number V1. In this example, it is determined that the read volume number “VOL001” and the access volume number V1 agree with each other.

Subsequently, the read write processing is executed in response to issue of the READ or WRITE. In this example, in this read write processing, as illustrated in Part (E) in FIG. 12, backup information is read from or written into the tape cartridge 110 of the access volume number V1 “VOL001”.

Further, in parallel with the read write processing, the swap processing in FIG. 10 is executed.

In this swap processing, the tape cartridge 110 stored in the cell 121 of the access cell number N is transferred to the cell 121 in which the tape cartridge 110 of the access volume number V1 has been stored. In this example, as illustrated in Part (E) in FIG. 12, the tape cartridge 110 of “VOL002” stored in the cell 121 of the access cell number N “1” is transferred to the cell 121 of the cell number “2”. In this example, at this stage, the interchange is corrected for the tape cartridge 110 of “VOL002”, but the correction at this stage does not always take place. Meanwhile, the interchange of the tape cartridge 110 targeted for access that is desired to be originally stored in the cell 121 of the access cell number N is corrected in response to issue of the UNLOAD which will be described later.

Subsequently, in response to the issue of the UNLOAD, the UNLOAD processing in FIG. 11 is executed. In this example, in this UNLOAD processing, as illustrated in Part (F) in FIG. 12, the tape cartridge 110 of the access volume number V1 “VOL001” loaded into the tape drive 130 is returned to the cell 121 of the access cell number “1”. At this stage, the interchange is corrected for the tape cartridge 110 targeted for access, which is not peculiar to this example.

In the example in FIG. 12 described above, the interchange is such an event that the tape cartridges 110 within the respective two cells 121 are merely interchanged. Therefore, the above-described processing, in which the tape cartridge 110 in one of the two cells 121 is targeted for access, corrects the interchange for both of the two tape cartridges 110.

However, when three or more tape cartridges 110 are interchanged, the above-described swapping is repeated twice or more so that all the interchanges are corrected.

Anyway, according to the library system 300 of the present embodiment, the interchange may be automatically corrected every time the tape cartridge 110 is accessed.

Next, a third embodiment will be described.

The third embodiment is different from the second embodiment in terms of the memory contents including the variable table in the RAM 203 possessed by the command conversion device, the structure of the command conversion device, and various kinds of processing executed by the command conversion device. In the following, the third embodiment will be described by focusing attention on these differences. Further, the entire structure of the library system in the third embodiment is equal to the entire structure of the library system 300 in the second embodiment illustrated in FIG. 3 and thus, illustration and overlapping description will be omitted. Incidentally, in the following, each element of the second embodiment illustrated in FIG. 3 through FIG. 6 will be referred to as each element of the present embodiment.

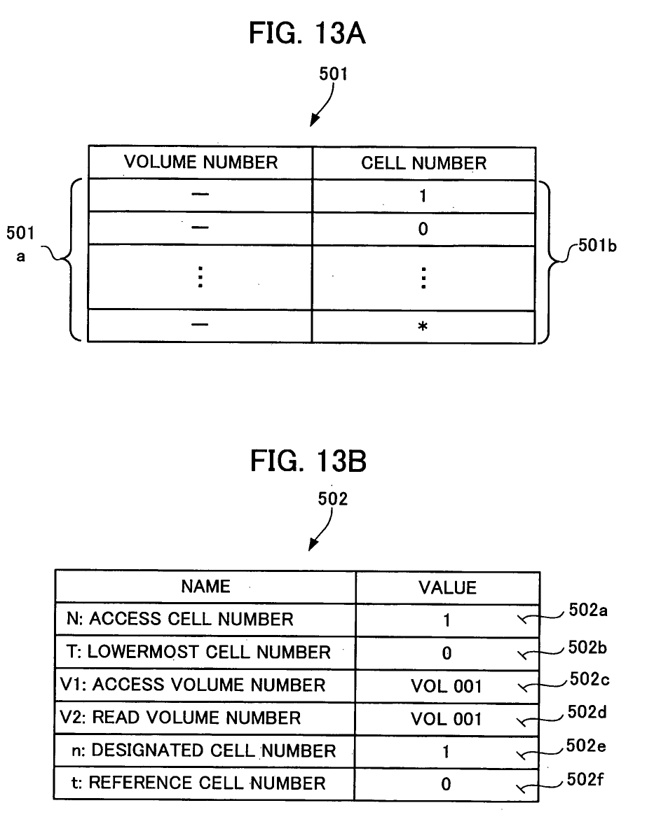

FIGS. 13A and 13B are diagrams that illustrate the memory contents including the variable table in the RAM of the command conversion device according to the third embodiment.

In the third embodiment, the RAM 203 stores: a correspondence table 501 in which correspondences between the volume numbers of the cartridge tapes 110 and the cell numbers of the cells 121 are recorded; and a variable table 502. The correspondence table 501 is illustrated in FIG. 13A, and the variable table 502 is illustrated in FIG. 13B.

The correspondence table 501 has volume-number storage fields 501a and cell-number storage fields 501b. In the present embodiment, the cell-number storage fields 501b are provided as many as the cells 121 in the magazine 120. In each of the cell-number storage fields 501b, the cell numbers are stored in ascending order as illustrated in FIG. 13A. Further, the volume-number storage fields 501a are provided in a one-to-one relationship with the cell-number storage fields 501b. Furthermore, in the present embodiment, when the magazine 120 is loaded into the tape library device 100, the contents of the volume-number storage fields 501a are erased as illustrated in FIG. 13A.

The variable table 502 of the present embodiment includes storage fields similar to those of the variable table 207 of the second embodiment illustrated in FIG. 7. Specifically, the variable table 502 in FIG. 13B includes a storage field 502a of the access cell number N, a storage field 502c of the access volume number V1, a storage field 502d of the read volume number V2, and a storage field 502e of the designated cell number n.

Further, in these storage fields, initial values similar to those of the second embodiment are stored as illustrated in FIG. 13B when the magazine 120 is loaded. In other words, “1” that is the cell number of the top cell 121 in the magazine 120 is stored in the storage field 502a of the access cell number N as the initial value. In the storage field 502e of the designated cell number n as well, the cell number “1” is stored as the initial value. In the storage field 502c of the access volume number V1, “VOL001” which is the volume number matching the cell number “1” is stored as the initial value. In the storage field 502d of the read volume number V2 as well, the volume number “VOL001” is stored as the initial value.

Furthermore, in addition to these storage fields, the variable table 502 in FIG. 13 includes a storage field 502b of a lowermost cell number T and a storage field 502f of a reference cell number t.

The lowermost cell number T is the cell number stored in the lowermost cell-number storage field 501b among the cell-number storage fields 501b for which the volume numbers are stored in the volume-number storage fields 501a in the correspondence table 501. The reference cell number t is a cell number targeted for reference, which will be described later, among the cell numbers stored in the correspondence table 501.

In these storage fields, the following initial values are stored when the magazine 120 is mounted. In the storage field 502b of the lowermost cell number T, “0” is stored as the initial value, because the volume-number storage field 501a of the correspondence table 501 is not yet filled when the magazine is loaded as described above. Further, in the storage field 502f of the reference cell number t as well, “0” is stored as the initial value.

Next, functional blocks of a command conversion device according to a third embodiment will be described.

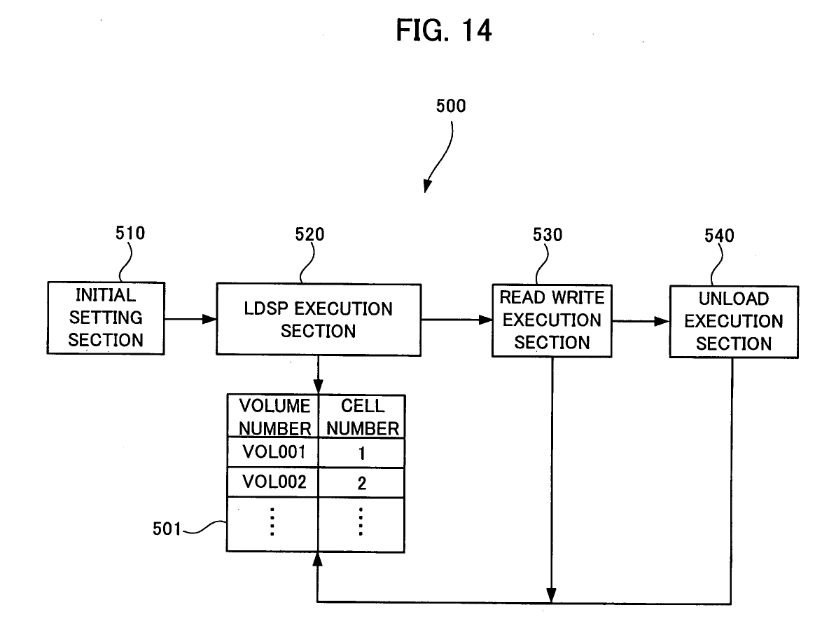

FIG. 14 is a functional block diagram that illustrates the command conversion device of the third embodiment.

A command conversion device 500 includes an initial setting section 510, an LDSP execution section 520, a read write execution section 530, and an UNLOAD execution section 540.

In the present embodiment, the command conversion device 500 in FIG. 14 is equivalent to a specific embodiment of the library control device according to the basic aspect described above.

In the present embodiment, the LDSP execution section 520 has a function of sequentially recording the volume numbers in ascending order of cell number in the volume-number storage fields 501a of the correspondence table 501 in the RAM 203. Further, the read write execution section 530 and the UNLOAD execution section 540 have a function of updating the contents stored in the volume-number storage fields 501a in the correspondence table 501.

Each of these elements will be described below along the flow of the backup processing executed in the library system 300.

At first, in response to the storage of the magazine 120 into the tape library device 100, the initial setting section 510 performs the following initial setting processing. As for the correspondence table 501 in FIG. 13A, the initial setting section 510 erases the contents of the volume-number storage fields 501a as described above. Further, the initial setting section 510 stores the initial values illustrated in the FIG. 13B in the respective storage fields of the variable table 502 in FIG. 13B. This initial setting processing in the present embodiment also is interrupt processing executed in response to the event of the loading of the magazine 120, like the initial setting processing in the second embodiment.

Next, the host device 400 issues the LDSP.

When the LDSP is issued, upon receipt of the LDSP, the LDSP execution section 520 in FIG. 14 performs LDSP processing as described below.

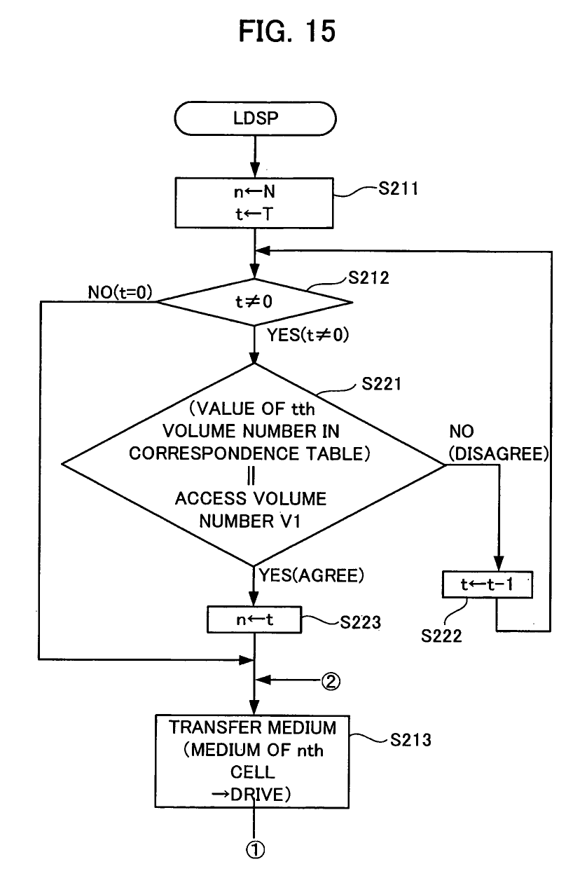

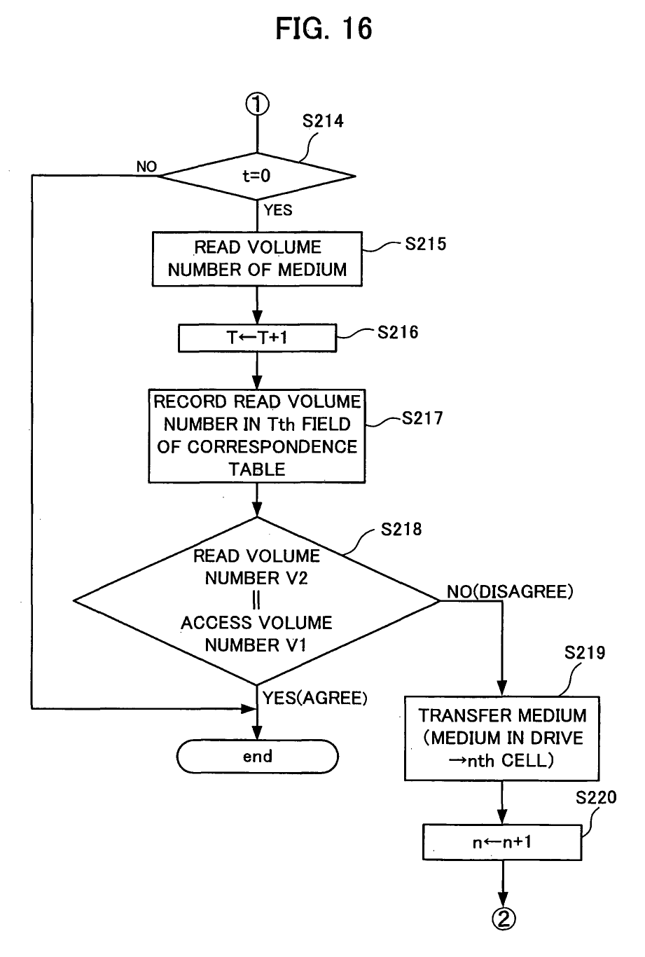

FIG. 15 is a flowchart that illustrates the first half of the LDSP processing in the third embodiment. Further, FIG. 16 is a flowchart that illustrates the latter half of the LDSP processing.

At first, the access volume number V1 attached to the LDSP is written over the storage field 502c of the access volume number V1 in the variable table 502 in FIG. 13B by the LDSP execution section 520. Further, the access cell number N stored in the storage field 502a of the access cell number N is read by the LDSP execution section 520, and the read access cell number N is written over the storage field 502e of the designated cell number n (step S211).

Furthermore, in this step S211, the lowermost cell number T is read from the variable table 502, and the value of the lowermost cell number T is written over the storage field 502f of the reference cell number t. At the time of the first issue of the LDSP, the initial value “0” of the lowermost cell number T is written over the storage field 502f of the reference cell number t in which “0” is stored as the initial value.

In the present embodiment, the LDSP execution section 520 is equivalent to an example of the designated-information acquisition section according to the basic aspect described above. Further, the processing in this step S211 is equivalent to an example of the operation of the designated-information acquisition section according to the basic aspect.

Subsequent to step S211, the reference cell number t is read from the variable table 502, and it is determined whether the reference cell number t is other than “0”, namely, whether the correspondence that may be referred is recorded in the correspondence table 501 (step S212).

Here, as mentioned earlier, the reference cell number t is “0” at the time of the first issue of the LDSP and therefore, this fact is obtained as a result of determination (NO in step S212), and the processing proceeds to step S213.

In step S213, the LDSP execution section 520 in FIG. 14 reads the designated cell number n from the variable table 502. Subsequently, the LDSP execution section 520 issues a command that designates the cell 121 by using the designated cell number n, thereby causing loading of the tape cartridge 110 from the designated cell 121 into the tape drive 130. The command issued in the processing of this step S213 is a command for random access type.

Next, it is determined whether the reference cell number t is “0” at this time (step S214). The meaning of the determination in this step S214 will be described later in detail.

When this step S214 is executed after going through NO determination in step S212, the reference cell number t is “0” and thus, this effect is obtained as a result of the determination (YES in step S214) and the processing proceeds to step S215.

In step S215, the LDSP execution section 520 in FIG. 14 issues a command that orders reading of the volume number from the tape cartridge 110 loaded into the tape drive 130. The command issued in the processing of this step S215 also is a command for random access type.

Further, in the processing of this step S215, the volume number (read volume number V2) read according to the command is transmitted from the tape library device 100 to the command conversion device 500. Subsequently, the LDSP execution section 520 writes the transmitted read volume number V2 over the storage field 502d of the read volume number V2 in the variable table 502 in FIG. 13B.

Next, the LDSP execution section 520 reads the lowermost cell number T from the variable table 502 described above, and adds “1” to the lowermost cell number T (step S216). Subsequently, the LDSP execution section 520 stores the lowermost cell number T after the addition in the storage field 502b of the lowermost cell number T in the variable table 502. By this addition of “1”, the lowermost cell number T in the variable table 502 becomes equal to the cell number of the cell 121 in which the tape cartridge 110 having the volume number read in step S215 has been stored. Subsequently, the LDSP execution section 520 stores the read volume number V2 read in step S214 in the volume-number storage field 501a, which corresponds to the lowermost cell number T after the addition, in the correspondence table 501 in FIG. 13A (step S217). In other words, the correspondence between the read volume number V2 and the cell number is recorded in the correspondence table 501 of FIG. 13A through this step S217.

In the LDSP processing executed for the first LDSP, when step S216 is executed after going through NO determination in step S212, the lowermost cell number T after the addition is “1”. In this case, in step S215, the volume number is read from the tape cartridge 110 in the cell 121 of the designated cell number n set to “1”. Further, in step S217, the cell number “1” and the read volume number V2 read from the tape cartridge 110 in the cell 121 of “1” are associated with each other and recorded in the correspondence table 501 in FIG. 13A.

Next, the LDSP execution section 520 checks whether the read volume number V2 of the variable table 502 in FIG. 13B and the access volume number V1 agree with each other (step S218).

When there is no interchange of the tape cartridges 110 and these volume numbers V2 and V1 agree with each other (YES in step S218), this LDSP processing is completed and then, the read write processing described below is executed.

On the other hand, when these volume numbers V2 and V1 disagree with each other (NO in step S218), a search for the tape cartridge 110 of the access volume number V1 is executed through a series of processes in this LDSP processing, which will be described below.

In this search, at first, the LDSP execution section 520 in FIG. 14 reads the designated cell number n from the variable table 502. Subsequently, the LDSP execution section 520 issues a command that designates the cell 121 by using the read designated cell number n, thereby causing a return of the tape cartridge 110 from the tape drive 130 to the designated cell 121 (step S219).

Next, the LDSP execution section 520 adds “1” to the designated cell number n read as described above, and writes the designated cell number n after the addition over the storage field 502e of the designated cell number n in the variable table 502 (step S220). Afterwards, the processing returns to step S213. Subsequently, through the processing from step S213 to S218, it is checked whether the read volume number V2 of the tape cartridge 110 in the cell 121 with the next cell number and the access volume number V1 agree with each other. At the time, the read volume number V2 of the tape cartridge 110 is stored in the volume-number storage field 501a corresponding to the lowermost cell number T at that moment of the correspondence table 501 illustrated in FIG. 13A. This lowermost cell number T is equal to the designated cell number n indicating the cell 121 in which the tape cartridge 110 of the volume number stored as described above has been stored.

Here, the processing of step S212 through S220 is repeatedly executed until the access volume number V1 and the read volume number V2 in the variable table 502 in FIG. 13B agree with each other. In the present embodiment, the tape cartridge 110 of the access volume number V1 is found from the plural tape cartridges 110 in the magazine 120 by such processing.

Further, in the present embodiment, the correspondence between the lowermost cell number T incremented one by one through this search and the volume number of the tape cartridge 110 stored in the cell 121 of each of the lowermost cell numbers T is sequentially recorded in the correspondence table 501 in FIG. 13A. In other words, in the present embodiment, the correspondence between the cell number and the volume number is sequentially recorded in the correspondence table 501 while the cell number is incremented one by one.

Here, for example, suppose the tape cartridge 110 having the access volume number V1 of “VOL001” is found from the cell 121 with the number 3. In this case, three correspondences in total between the cell numbers from one to three and the volume numbers of the tape cartridges 110 in the respective cells 121 having the numbers from one to three are recorded in the correspondence table 501.

In the present embodiment, in this way, together with the search for the tape cartridge 110 of the access volume number V1, recording of the correspondence in the correspondence table 501 in FIG. 13A is performed.

So far, the LDSP processing executed in response to the first LDSP has been described. Now, the LDSP processing executed in response to the second or later LDSP will be described.

In the LDSP processing executed in response to the second or later LDSP as well, at first, in step S211 in FIG. 15, the access cell number N is written over the storage field 502e of the designated cell number n in the variable table 502 is executed. Further, the value of the lowermost cell number T is written over the storage field 502f of the reference cell number t in the variable table 502 is executed as well.

Here, at the time of executing the LDSP processing in response to the second or later LDSP, the recording in the correspondence table 501 in FIG. 13A is executed by the LDSP processing according to the last LDSP as described above. After the recording, the lowermost cell number T is the cell number in the latest recorded correspondence. Further, in step S211 of the LDSP processing executed in response to the second or later LDSP, the cell number in the latest recorded correspondence in the previous LDSP processing is written over the storage field 502f of the reference cell number t.

For this reason, in the LDSP processing executed in response to the second or later LDSP, unlike the LDSP processing executed in response to the first LDSP, it is determined that the reference cell number t is other than “0” in step S212 (YES in step S212). As a result, in this LDSP processing, the flow proceeds to step S221.

In this step S221, the volume number is read from the volume-number storage field 501a corresponding to the reference cell number t in the correspondence table 501 at this moment. Subsequently, the read volume number is attached to the current LDSP, and it is determined whether the read volume number agrees with the access volume number V1 recorded in the variable table 502 in FIG. 13B.

When the read volume number and the access volume number V1 do not agree with each other (NO in step S221), the reference cell number t is read from the variable table 502, and “1” is subtracted from the reference cell number t (step S222). Subsequently, the reference cell number t after the subtraction is written over the storage field 502f of the reference cell number t. Afterwards, step S212 and step S221 described above are repeated.

This processing is repeatedly executed, until either a condition in which the volume number matching with the access volume number V1 is found in the correspondence table 501 or a condition in which the reference cell number t in the variable table 502 becomes “0” is satisfied.

When the volume number matching with the access volume number V1 is found in the correspondence table 501 (YES in step S221), the value of the reference cell number t at the time is written over the storage field 502e of the designated cell number n (step S223). The reference cell number t at the time is, in the correspondence table 501, the cell number corresponding to the access volume number V1 in the current LDSP.

Subsequently, in the processing of step S213 following this step S223, a command that designates the cell 121 by use of the designated cell number n set in the reference cell number t is issued, so that the tape cartridge 110 is loaded from the designated cell 121 into the tape drive 130.

In the processing of step S214 after going through step S223, it is determined that the reference cell number t is other than “0” (NO in step S214). In this case, the tape cartridge 110 of the access volume number V1 is already found and loaded into the tape drive 130. Therefore, the processing in step S215 through S220 concerning the search for the tape cartridge 110 is omitted, and the LDSP processing is completed.

Here, the repetition of step S212 and step S221 may be stopped when the reference cell number t becomes “0” and NO is obtained as a result of the determination in step S212. This case means that in the correspondence table 501, there is no volume number matching with the access volume number V1 attached to the current LDSP. In other words, this case means that there is a correspondence yet to be recorded in the correspondence table 501.

In this case, YES is obtained as a result of the determination in step S214, steps S215 through S220 are executed, and a search for the tape cartridge 110 and additional recording of a new correspondence in the correspondence table 501 are executed.

In the present embodiment, such LDSP processing is repeated plural times, so that for each of all the tape cartridges 110 stored in the tape library device 100, the correspondence between the volume number and the cell number is recorded in the correspondence table 501. Subsequently, after the correspondence is recorded for each of all the tape cartridges 110, the search for the tape cartridge 110 of the access volume number V1 is executed only based on the correspondence table 501.

In the present embodiment, the LDSP execution section 520 is equivalent to an example of the loading control section according to the basic aspect described above. Further, the processing of step S212 through S220 is equivalent to an example of the operation of the loading control section according to the basic aspect.

When the tape cartridge 110 of the access volume number V1 is found and loaded into the tape drive 130, the command conversion device 200 informs the host device 400 of this effect. Then, the host device 400 issues the READ or WRITE. Further, at the time when the WRITE is issued, the host device 400 also performs transmission of the backup information following the issue of the command.

Upon receipt of any of these commands or backup information, the read write execution section 530 (FIG. 14) of the command conversion device 200 executes the read write processing.

When the WRITE and the backup information are transmitted and arrive, the read write execution section 530 issues a command that orders writing of the backup information into the tape cartridge 110 being loaded. When the READ is transmitted and arrives, the read write execution section 530 issues a command that orders reading of the backup information from the tape cartridge 110 being loaded. Subsequently, the backup information is sent from the tape library device 100 in response to this command, and upon receipt of the backup information, the read write execution section 530 sends the backup information to the host device 400. The command in this read write processing also is a command for random access type.

Here, while the tape drive 130 writes or reads the backup information, the read write execution section 530 performs swap processing as described below.

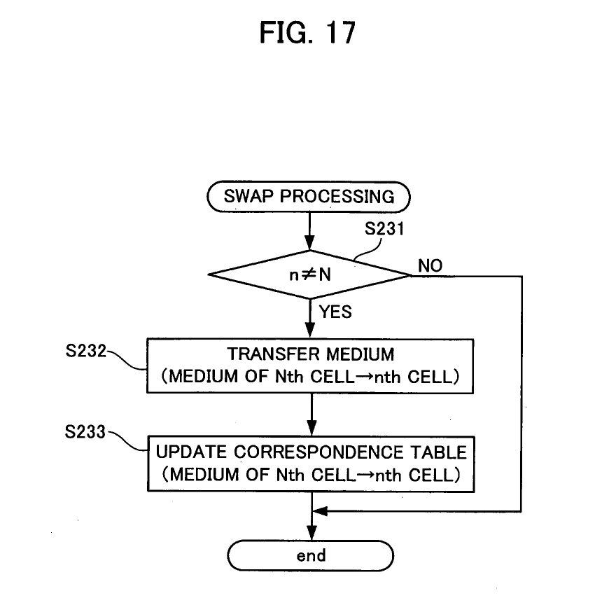

FIG. 17 is a flowchart that illustrates the swap processing of the third embodiment.

At first, the read write execution section 530 reads the access cell number N and the designated cell number n from the variable table 502 in FIG. 13B at the time of starting this swap processing, and determines whether these numbers disagree with each other (step S231).

When the access cell number N and the designated cell number n in the variable table 502 disagree with each other (YES in step S231), at first, processing in the next step S232 is executed.

In step S232, the read write execution section 530 issues a command that designates the cell 121 of the transfer origin by using the access cell number N and also designates the cell 121 of the transfer destination by using the designated cell number n, so that the tape cartridge 110 is transferred from the transfer origin to the transfer destination. Incidentally, at the time of step S232, the cell 121 of the designated cell number n is already empty as a result of the execution of step S213 in the LDSP processing in FIG. 15. Subsequently, in this step S232, the cell 121 of the access cell number N, in which the tape cartridge 110 currently being accessed is desired to be stored, is emptied.

In the present embodiment, the read write execution section 530 is equivalent to an example of the transfer control section according to the basic aspect described above. Further, the processing of step S232 is equivalent to an example of the operation of the transfer control section according to the basic aspect.

Furthermore, for the correspondence recorded in the correspondence table 501, the following update is executed (step S233).

In this step S233, in the correspondence table 501, the volume number recorded in the volume-number storage field 501a corresponding to the access cell number N is moved to the volume-number storage field 501a corresponding to the designated cell number n. Through the processing of this step S233, in the correspondence table 501, the volume-number storage field 501a corresponding to the access cell number N at present is emptied.

When YES is obtained as a result of the determination in step S231 described above, this read write processing ends upon completion of the updating of the correspondence in step S233.

On the other hand, in step S231 described above, when the access cell number N and the designated cell number n agree with each other (NO in step S231), step S232 and step S233 are omitted, and this read write processing ends.

When the read write processing and the swap processing described above are completed, the command conversion device 200 informs the host device 400 of this effect. Then, the host device 400 issues the UNLOAD. Upon receipt of this UNLOAD, the UNLOAD execution section 540 of the command conversion device 200 executes the UNLOAD processing.

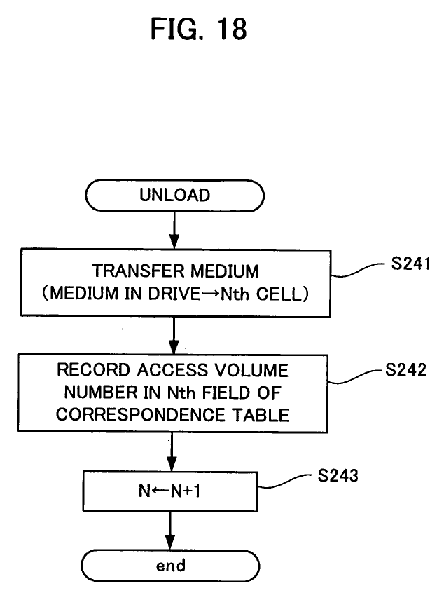

FIG. 18 is a flowchart that illustrates the UNLOAD processing of the third embodiment.

In the UNLOAD processing, at first, the UNLOAD execution section 540 reads the access cell number N from the variable table 502 in FIG. 13B.

Subsequently, the UNLOAD execution section 240 issues a command that designates the cell 121 by using the access cell number N, thereby causing transfer of the tape cartridge 110 from the tape drive 130 to the designated cell 121 (step S241). The accessor 140 stores the tape cartridge 110 targeted for access in the cell 121 of the access cell number N according to the command.

When the tape cartridge 110 targeted for access has been originally stored in the cell 121 of the access cell number N, this step S241 is merely a process of returning the tape cartridge 110 targeted for access to the original cell 121.

On the other hand, when the tape cartridge 110 targeted for access has been stored in the cell 121 different from the cell 121 of the access cell number N, step S241 is a process of storing the tape cartridge 110 in the correct cell 121.

Next, the UNLOAD execution section 540 performs the following update for the correspondence in the correspondence table 501 (step S242).

In this step S242, the access volume number V1 is recorded in the volume-number storage field 501a corresponding to the access cell number N in the correspondence table 501.

When there is no interchange and the access volume number V1 is already recorded in the volume-number storage field 501a corresponding to the access cell number N in the correspondence table 501, this step S242 is mere overwriting processing. On the other hand, when there is an interchange, the volume-number storage field 501a corresponding to the access cell number N in the correspondence table 501 is emptied by the processing of step S233 in FIG. 17. In this case, step S242 in FIG. 18 is processing of recording the access volume number V1 in the correct volume-number storage field 501a corresponding to this access cell number N.

In the present embodiment, through the update of step S233 in FIG. 17 and the update of step S242 in FIG. 18, the correspondence between the volume number and the cell number of the tape cartridge 110 having the access volume number V1 is corrected to result in the right correspondence.

Upon completion of the processing in step S242, the UNLOAD execution section 540 adds “1” to the access cell number N read in step S241, and writes the access cell number N after the addition over the storage field 502a of the access cell number N (step S243). Subsequently, the UNLOAD execution section 540 ends this UNLOAD processing upon completion of this overwriting.

The UNLOAD execution section 540 that performs the UNLOAD processing described above is equivalent to an example of the medium storage control section in the basic aspect.

For the above-described preferable aspect in which the loading control section includes the storage location indication section, the storage information acquisition section and the selection section, there is a further preferable aspect as follows. In this preferable aspect, the loading control section further includes a correspondence recording section, a correspondence updating section and a correspondence updating section. The correspondence recording section records a correspondence between the storage medium represented by the stored-medium information acquired by the storage information acquisition section and a storage location where the storage medium is stored. The correspondence updating section updates the correspondence recorded by the correspondence recording section, when transfer of the storage medium is ordered by the transfer control section. The second selection section substitutes the selection section serving as a first selection section and selects the storage location represented by the correspondence when the correspondence is already recorded for the storage medium designated by the medium-designating information, so that the selected storage location is indicated to the library device by the storage location indication section.

According to this preferable aspect, when the correspondence is already recorded for the storage medium designated by the medium-designating information, the loading control section indicates the storage location by using the correspondence. Thus, efficiency of the processing in the loading control section is improved.

In the present embodiment, the LDSP execution section 520 is equivalent to an example of the correspondence recording section in this preferable aspect. Further, the processing in step S215 through S217 of the LDSP processing is equivalent to an example of the operation of the correspondence recording section in this preferable aspect.

Furthermore, in the present embodiment, the LDSP execution section 520 is also equivalent to an example of the second selection section in this preferable aspect. The processing in step S212 through S220 is equivalent to an example of the operation of the second selection section in this preferable aspect.

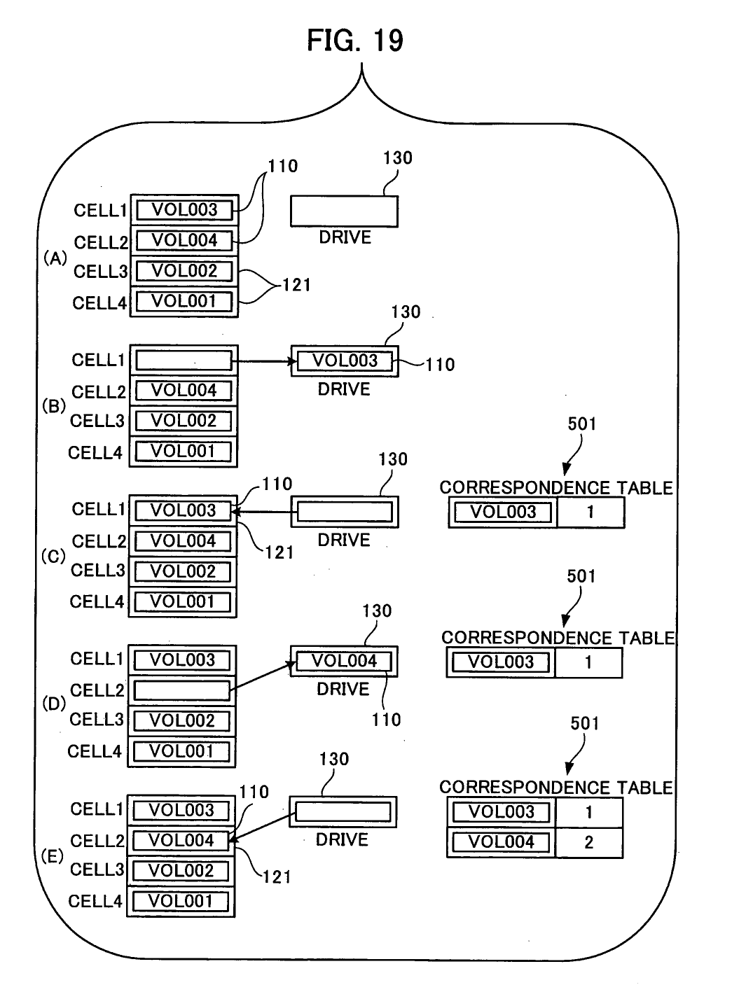

In the present embodiment, the read write execution section 530 and the UNLOAD execution section 540 combined are equivalent to an example of the correspondence updating section in this preferable aspect. Further, the processing of step S233 in FIG. 18 and the processing of step S242 in FIG. 19 combined are equivalent to an example of the operation of the correspondence updating section in this preferable aspect.

Now, although slightly overlapping the description provided above with reference to each processing of FIG. 14 through FIG. 19, a process up to completion of automatic correction of the interchange in the present embodiment will be described by using a specific example of the interchange.

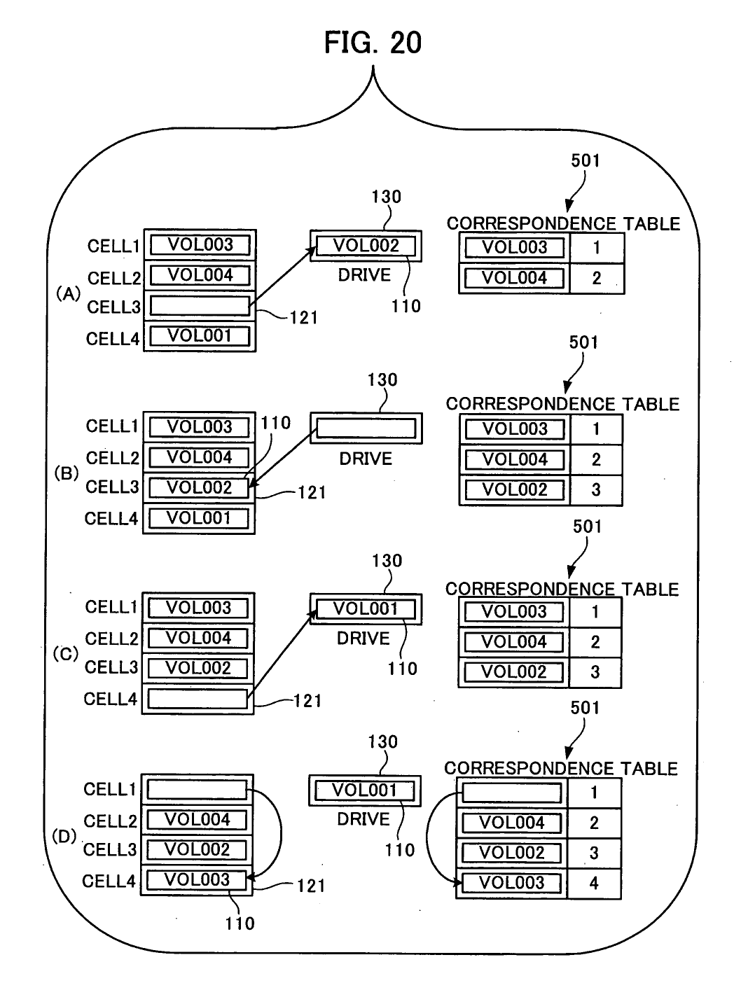

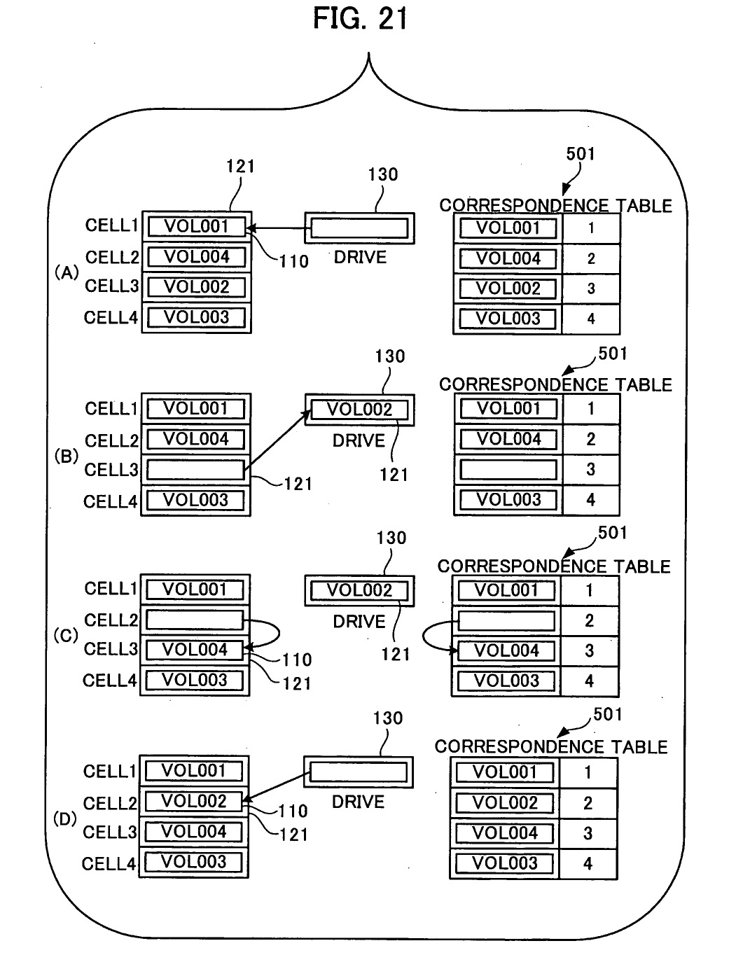

FIG. 19 is a diagram that illustrates the first one-third of the process up to completion of the automatic correction of the interchange. Further, FIG. 20 is a diagram that illustrates the next one-third of this process following what is illustrated in FIG. 19. Further, FIG. 21 is a diagram that illustrates the last one-third of this process.

FIG. 19 through FIG. 21 illustrate a state in which interchanges to be described later are automatically corrected for four tape cartridges 110 having the volume numbers “VOL001” through “VOL004” stored in four cells 121 having the cell numbers “1” through “4”. In the present embodiment as well, the correction of the interchange is executed every time access is made. For this reason, in each of FIG. 19 through FIG. 21, the tape drive 130 that accesses the tape cartridge 110 also is illustrated. Further, in the present embodiment, the correspondence between the volume number and the cell number is recorded in the correspondence table 501, and the correction based on the recorded correspondence is performed. For this reason, the correspondence table 501 also is illustrated in each of FIG. 19 through FIG. 21.

At first, in this example, all of the four tape cartridges 110 having the volume numbers “VOL001” through “VOL004” are stored in wrong cells 121 as illustrated in Part (A) of FIG. 19.

In such a state, at first, in response to the issue of the first LDSP, the LDSP processing in FIG. 15 and FIG. 16 is executed. To this first LDSP, “VOL001” is attached as the access volume number V1.

Then, in the processing of step S213 in FIG. 15, as illustrated in Part (B) in FIG. 19, the tape cartridge 110 of “VOL003” stored in the cell 121 of the access cell number N “1” is loaded into the tape drive 130.

Subsequently, in the processing of step S215 through S217 in FIG. 16, as illustrated in Part (C) in FIG. 19, the following correspondence between the volume number and cell number is recorded in the correspondence table 501. The volume number in this correspondence is the volume number “VOL003” read from the tape cartridge 110 loaded into the tape drive 130 as described above. On the other hand, the cell number in this correspondence is the cell number “1” of the cell 121 in which the tape cartridge 110 has been stored.

Further, in the processing of step S218 in FIG. 16, a comparison between the read volume number V2 and the read access volume number V1 is performed. In this example, the former is “VOL003” and the latter is “VOL001” and therefore, it is determined that there is a disagreement. As a result, in the processing of step S219 in FIG. 16, as illustrated in Part (C), the tape cartridge 110 of “VOL003” loaded into the tape drive 130 is returned to the original cell 121 of the access cell number N “1”.

Next, in the processing of step S220 in FIG. 16 and step S213 in FIG. 15, as illustrated in Part (D) in FIG. 19, the tape cartridge 110 stored in the cell 121 of the cell number “2”, instead of the access cell number N “1”, is loaded into the tape drive 130.

Subsequently, the processing of step S215 through S217 in FIG. 16 is executed again. As a result, as illustrated in Part (E) in FIG. 19, the following correspondence is recorded in the correspondence table 501. This correspondence is a correspondence between the volume number “VOL004” read from the tape cartridge 110 loaded into the tape drive 130 as described above and the cell number “2” of the cell 121 in which that tape cartridge 110 has been stored.

Then, the processing of step S218 in FIG. 16 is executed again. As a result, a comparison between the read volume number V2 and the access volume number V1 is performed. In this example, the former is “VOL004” and the latter is “VOL001” and therefore, it is determined that there is a disagreement. As a result, in the processing of step S219 in FIG. 16, as illustrated in Part (E), the tape cartridge 110 of “VOL004” loaded into the tape drive 130 is returned to the original cell 121 of the cell number “2”.

Next, in the processing of step S220 in FIG. 16 and step S213 of FIG. 15, as illustrated in Part (A) in FIG. 20, the tape cartridge 110 stored in the cell 121 of the cell number “3” is loaded into the tape drive 130.

Subsequently, the processing of step S215 through S217 in FIG. 16 is executed again. As a result, as illustrated in Part (B) in FIG. 20, the correspondence between the volume number “VOL002” and the cell number “3” is recorded in the correspondence table 501. The processing of step S218 in FIG. 16 is performed again, in which it is determined that the two volume numbers disagree with each other, and as illustrated in this Part (B), the tape cartridge 110 is returned to the original cell 121.

Next, in the processing of step S220 in FIG. 16 and step S213 in FIG. 15, as illustrated in Part (C) in FIG. 20, the tape cartridge 110 stored in the cell 121 of the cell number “4” is loaded into the tape drive 130.

Subsequently, the processing of step S215 through S217 in FIG. 16 is executed again. As a result, at first, the correspondence between the volume number “VOL001” and the cell number “4” is recorded in the correspondence table 501. Further, the processing of step S218 in FIG. 16 is executed again, in which it is determined this time that the two volume numbers agree with each other. Subsequently, the read write processing in FIG. 17 and the swap processing in FIG. 18 are executed. As a result of this swap processing, as illustrated in Part (D), the tape cartridge 110 of “VOL003” stored in the cell 121 of the access cell number N “1” is moved to the cell 121 of the cell number “4”. Further, in the swap processing, as illustrated in Part (D), the volume number “VOL003” corresponding to the access cell number N “1” is moved to the volume-number storage field 501a corresponding to the cell number “4” in the correspondence table 501.

Next, the UNLOAD processing in FIG. 19 is executed, as illustrated in Part (A) in FIG. 21, the tape cartridge 110 of the access volume number V1 “VOL001” is returned to the cell 121 of the access cell number N “1”.

Further, in this UNLOAD processing, as illustrated in this Part (A), the access volume number V1 “VOL001” is stored in the volume-number storage field 501a corresponding to the access cell number N “1” in the correspondence table 501. In this example, at this stage, the interchange is corrected for the tape cartridge 110 of the volume number “VOL001”.

Subsequently, in response to the issue of the second LDSP, the LDSP processing in FIG. 15 and FIG. 16 is executed again. To the second LDSP, “VOL002” is attached as the access volume number V1.

In this second LDSP processing, through the processing of step S221 to S223 in FIG. 15, the cell number “3” corresponding to the current access volume number V1 “VOL002” is found in the correspondence table 501. Subsequently, as illustrated in Part (B) of FIG. 21, the tape cartridge 110 of the access volume number V1 “VOL002” stored in the cell 121 of the found cell number “3” is loaded into the tape drive 130.

Further, the read write processing in FIG. 17 and the swap processing in FIG. 18 are executed again.

As illustrated in Part (C) in FIG. 21, in the swap processing, the tape cartridge 110 of the access volume number V1 “VOL004” in the cell 121 of the access cell number N “2” is moved to the cell 121 of the cell number “3” as mentioned above. Further, in this swap processing, the volume number “VOL004” corresponding to the access cell number N “2” is moved to the volume-number storage field 501a corresponding to the cell number “3” in the correspondence table 501.

Subsequently, the UNLOAD processing in FIG. 19 is executed again, and as illustrated in Part (D) of FIG. 21, the tape cartridge 110 of the access volume number V1 “VOL002” is returned to the cell 121 of the access cell number N “2”. Further, in this UNLOAD processing, the access volume number V1 “VOL002” is stored in the volume-number storage field 501a corresponding to the access cell number N “2” in the correspondence table 501. In this example, at this stage, the interchange is corrected for the tape cartridge 110 of the volume number “VOL002”.

Although description of the third LDSP processing to be executed subsequently and the like will be omitted, in this example, at the time of executing the third LDSP processing, read write processing, swap processing and UNLOAD processing, the remaining interchange is similarly corrected.

As described above, in the library system 300 of the present embodiment as well, every time the tape cartridge 110 is accessed, the interchange is automatically corrected. Further, in the present embodiment, at the time of the search for the tape cartridge 110 targeted for access, the correspondence between each cell number and the volume number of the tape cartridge 110 actually stored is recorded. In the present embodiment, the correspondence already recorded is used for the subsequent access of the tape cartridge 110 and the correction of the interchange and thus, efficiency of the processing is improved.

Next, a fourth embodiment will be described.

The fourth embodiment is different from the second embodiment in terms of the memory contents including the variable table in the RAM 203 possessed by the command conversion device, the structure of the tape library device, the structure of the command conversion device, and various kinds of processing executed by the command conversion device. In the following, the fourth embodiment will be described by focusing attention on these differences. Further, the entire structure of the library system in the fourth embodiment is equal to the entire structure of the library system 300 in the second embodiment illustrated in FIG. 3 and thus, illustration and overlapping description will be omitted. Incidentally, in the following, each element of the second embodiment illustrated in FIG. 3 through FIG. 6 will be referred to as each element of the present embodiment.

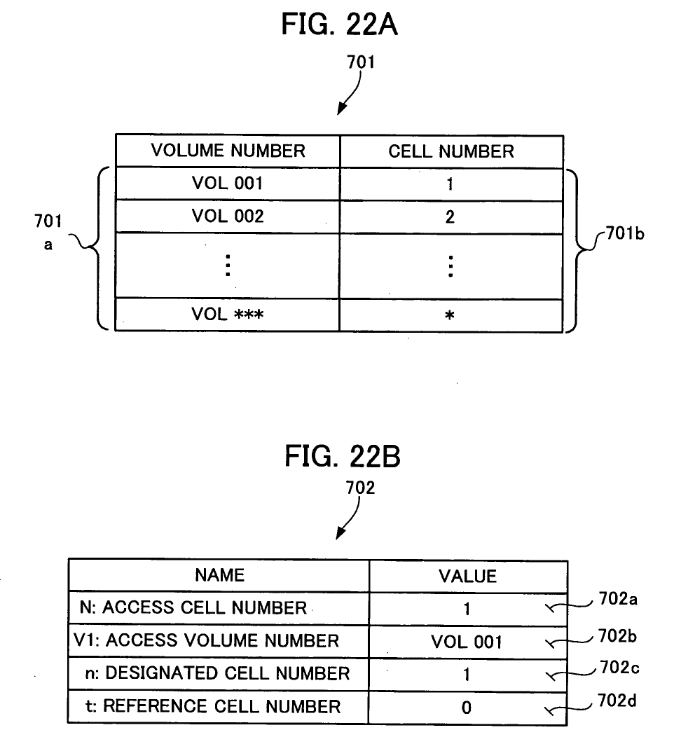

FIGS. 22A and 22B are diagrams that illustrate the memory contents including the variable table in the RAM of the command conversion device according to the fourth embodiment.

In the fourth embodiment, the RAM 203 stores: a correspondence table 701 in which the correspondence between the volume number of a cartridge tape 610 and the cell number of the cell 121 is recorded; and a variable table 702. The correspondence table 701 is illustrated in FIG. 22A, the variable table 702 is illustrated in FIG. 22B.

The correspondence table 701 has volume-number storage fields 701a and cell-number storage fields 701b. The cell-number storage fields 701b are provided as many as the cells 121 in the magazine 120. Further, in the respective cell-number storage fields 701b, the cell numbers are stored in ascending order as illustrated in FIG. 22A. Furthermore, the volume-number storage fields 701a are provided in a one-to-one relationship with the cell-number storage fields 701b.

In the present embodiment, at the time when the magazine 120 is loaded into the tape library device 100, the volume numbers corresponding to all the cell numbers are stored in the volume-number storage fields 701a through initial setting processing that will be described later.

The variable table 702 of the present embodiment has the following storage fields similar to those of the variable table 207 in the second embodiment illustrated in FIG. 7. In other words, the variable table 702 in FIG. 22 has a storage field 702a of the access cell number N, a storage field 702b of the access volume number V1, and a storage field 702c of the designated cell number n.

Further, in these storage fields, as illustrated in FIG. 22B, initial values similar to those of the second embodiment are stored at the time when the magazine 120 is loaded.

Further, the variable table 702 in FIG. 22B has, in addition to these storage fields, a storage field 702d of the reference cell number t. This reference cell number t is a cell number that may be targeted for reference to be described later among the cell numbers stored in the correspondence table 701. In the storage field 702d of this reference cell number t, “0” is stored as the initial value at the time when the magazine 120 is loaded.

Next, functional blocks of the command conversion device in the fourth embodiment will be described.

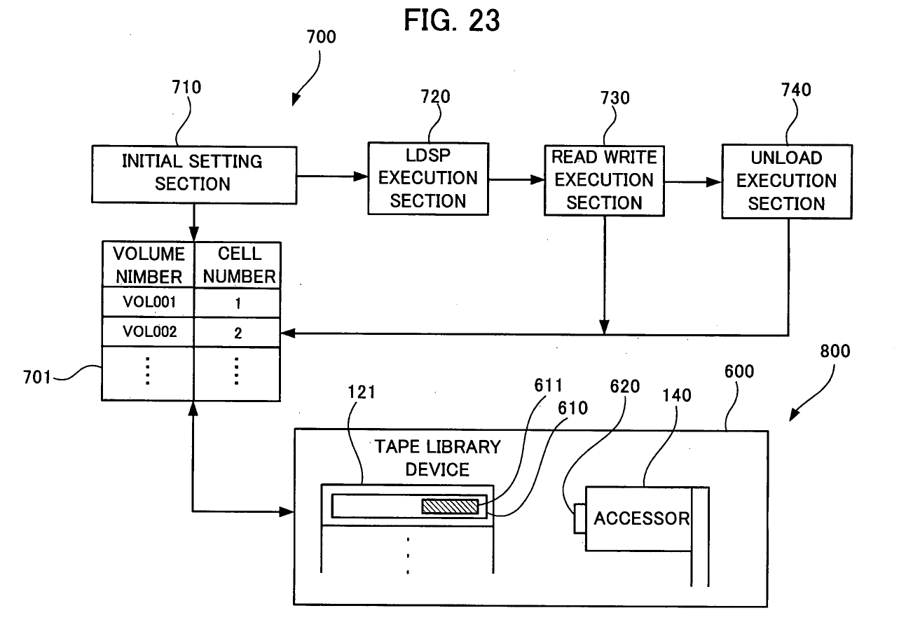

FIG. 23 is a functional block diagram that illustrates the library system of the fourth embodiment.

FIG. 23 illustrates a tape library device 600 of a library system 800 of the fourth embodiment by focusing on features different from the tape library device 100 of the library system 300 in the second embodiment illustrated in FIG. 3.

In the present embodiment, a command conversion device 700 in FIG. 23 is equivalent to a specific embodiment of the library control device according to the basic aspect described above. Further, in the present embodiment, the tape library device 600 in FIG. 23 is equivalent to an example of the library device according to the basic aspect described above.

In the present embodiment, a bar code label 611, on which a bar code representing the volume number of the tape cartridge 610 is printed, is affixed to the surface of the tape cartridge 610 stored in the cell 121 in the tape library device 600.

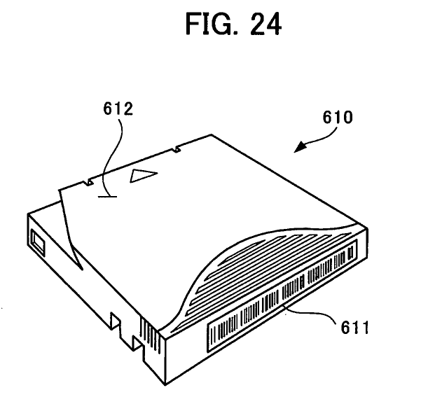

FIG. 24 is an external perspective diagram of the tape cartridge in the fourth embodiment.

FIG. 24 is the perspective diagram of the tape cartridge 610 with the bar code label 611 being directed frontward in FIG. 24.

This tape cartridge 610 has an appearance and a structure similar to those of the tape cartridge 110 in the second embodiment described above with reference to FIG. 4 and FIG. 5. In other words, the tape cartridge 610 in FIG. 24 also has such a structure that a magnetic tape wound around a reel is housed in a rectangular shell 612. However, in the tape cartridge 610 illustrated in FIG. 24, the volume number is not recorded in the magnetic tape provided inside, but instead, the volume number is recorded as a bar code on the bar code label 611.

Further, in the present embodiment, as illustrated in FIG. 23, a bar code reader 620 to read the bar code of the bar code label 611 described above is attached to the accessor 140 of the tape library device 600.

Incidentally, the tape library device 600 of the present embodiment is equivalent to the tape library device 100 in FIG. 3 in terms of the structure such as a tape drive, except the bar code label 611 and the bar code reader 620. In the following, as for the tape library device 600 of the present embodiment, overlapping description of the same structure as that of the tape library device 100 in FIG. 3 will be omitted. Further, in the following, the same elements of the tape library device 100 in FIG. 3 as those of the tape library device 600 in the present embodiment will be referred to as those elements of the tape library device 600.

The command conversion device 700 of the present embodiment includes an initial setting section 710, an LDSP execution section 720, a read write execution section 730 and an UNLOAD execution section 740.

In the present embodiment, the initial setting section 710 has a function of recording the volume numbers in the volume-number storage fields 701a in the correspondence table 701 illustrated in FIG. 22A. Further, the read write execution section 730 and the UNLOAD execution section 740 have a function of updating the contents stored in the volume-number storage fields 701a in the correspondence table 710.

Each of these elements will be described below along the flow of backup processing executed in the library system 800.

First, in response to loading of the magazine 120 into the tape library device 600, the initial setting section 710 in FIG. 23 performs initial setting processing described below.

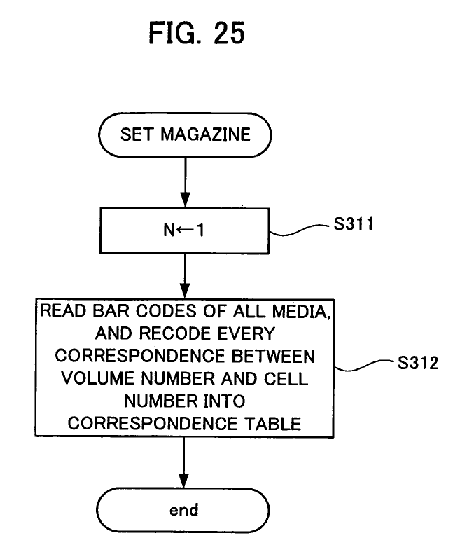

FIG. 25 is a flowchart that illustrates the initial setting processing in the fourth embodiment.

In the present embodiment, in response to loading of the magazine 120, at first, the initial setting section 710 performs the initial setting processing for storing each initial value illustrated in FIG. 22 in the variable table 702 (step S311).

Next, the initial setting section 710 issues, to the tape library device 600, a command that orders reading of the bar codes of all the tape cartridges 610 by the bar code reader 620 (step S312). In the processing of this step S312, a result of reading according to this command is sent from the tape library device 600 to the command conversion device 700. This result of reading is received by the initial setting section 710 of the command conversion device 700. As a result, the initial setting section 710 obtains the volume number of each of the tape cartridges 610. Further, the initial setting section 710 records each of the volume numbers in the volume-number storage field 701a corresponding to the cell number of the cell 121 in which the tape cartridge 610 of each of the volume numbers is stored, in the correspondence table 701.

In the present embodiment, through the processing in this step S312, the correspondence between the volume number and the cell number is recorded in the correspondence table 701 for all the tape cartridges 610 in the tape library device 600.

In the present embodiment, the initial setting processing ends upon completion of recording of the correspondence for all the tape cartridges 610 in this the correspondence table 701.

Next, when the host device 400 issues the LDSP, upon receipt of the LDSP, the LDSP execution section 720 in FIG. 23 executes LDSP processing described below.

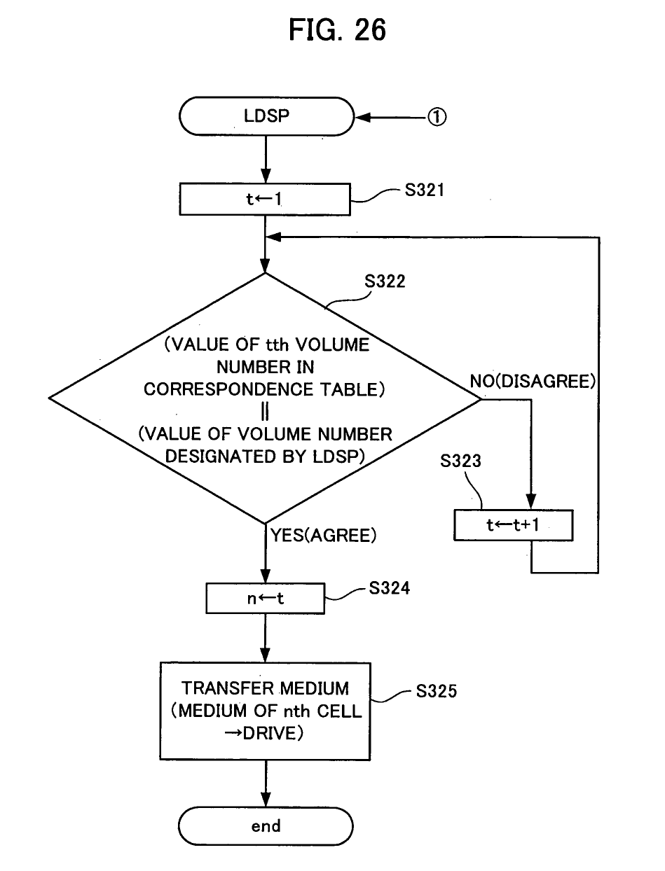

FIG. 26 is a flowchart that illustrates the LDSP processing in the fourth embodiment.

First, in the LDSP execution section 720, the access volume number V1 attached to the LDSP is written by the LDSP execution section 720 over the storage field 702b of the access volume number V1 in the variable table 702 in FIG. 22B (step S321). Further, in the processing of this step S321, “1” that is the uppermost cell number is written over the storage field 702d of the reference cell number t in the variable table 702.

In the present embodiment, the LDSP execution section 720 is equivalent to an example of the designated-information acquisition section according to the basic aspect described above. Further, the processing in step S321 is equivalent to an example of the operation of the designated-information acquisition section according to the basic aspect.

Next, the LDSP execution section 720 reads the reference cell number t and the access volume number V1 from the variable table 702. Subsequently, it is determined whether the volume number corresponding to the reference cell number t agrees with the access volume number V1 in the correspondence table 701 at this moment (step S322).

When the volume number and the access volume number V1 do not agree with each other (NO in step S322), “1” is added to the reference cell number t read in step S322, and the reference cell number t after the addition is written over the storage field 702d of the reference cell number t in the variable table 702 (step S323). Subsequently, the processing in this step S322 is repeatedly executed until the volume number matching with the access volume number V1 is found in the correspondence table 701.

When the volume number matching with the access volume number V1 is found in the correspondence table 701 (YES in step S322), the value of the reference cell number t at this moment is written over the storage field 702c of the designated cell number n (step S324). The reference cell number t at this moment is the cell number corresponding to the access volume number V1 in the current LDSP, in the correspondence table 701.

Next, the LDSP execution section 720 reads the designated cell number n from the variable table 702. Subsequently, the LDSP execution section 720 issues a command that designates the cell 121 by using the designated cell number n, thereby causing loading of the tape cartridge 610 from the designated cell 121 to the tape drive 130 (step S325).

In the present embodiment, the LDSP execution section 720 is equivalent to an example of the loading control section according to the basic aspect described above. Further, the processing in step S322 through S325 is equivalent to an example of the operation of the loading control section according to the basic aspect.

Through the LDSP processing described above, when the tape cartridge 610 of the access volume number V1 is found and loaded into the tape drive 130, the command conversion device 700 informs the host device 400 of this effect. Then, the host device 400 issues the READ or WRITE. Further, at the time of issuing the WRITE, the host device 400 performs transmission of backup information subsequent to the issue of the command.

Upon receipt of these commands and the backup information, the read write execution section 730 (FIG. 23) of the command conversion device 700 performs read write processing.

When the WRITE and the backup information are transmitted and arrive, the read write execution section 730 issues a command that orders writing of the backup information into the tape cartridge 610 being loaded. When the READ is transmitted and arrives, the read write execution section 730 issues a command that orders reading of the backup information from the tape cartridge 610 being loaded. The backup information is sent from the tape library device 600 in response to this command, and upon receipt of the backup information, the read write execution section 730 sends the backup information to the host device 400. These commands also are commands for the random access type.

Here, while the tape drive 130 writes or reads the backup information, the read write execution section 730 executes swap processing described below.

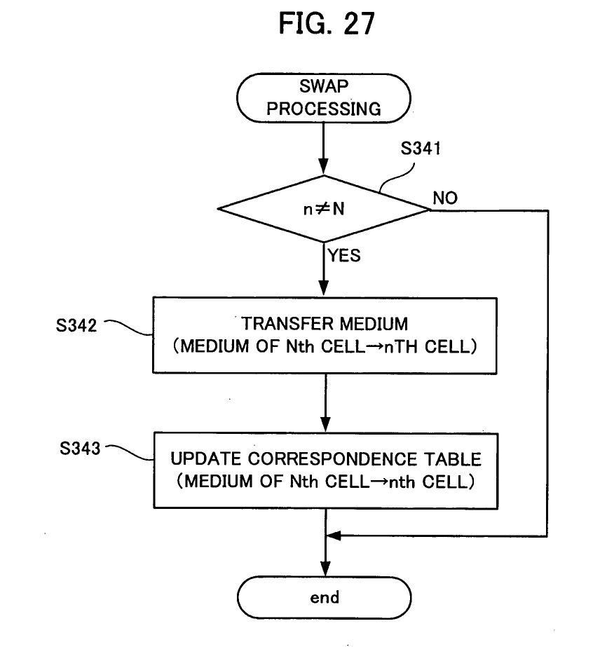

FIG. 27 is a flowchart that illustrates the swap processing in the fourth embodiment.

First, the read write execution section 730 reads the access cell number N and the designated cell number n from the variable table 702 described above, and determines whether these read numbers are different from each other (step S341).

When the access cell number N and the designated cell number n are different from each other (YES in step S341), first, processing in the next step S342 is executed.

In step S342, the read write execution section 730 issues a command that designates the cell 121 of the transfer origin by using the access cell number N and designates the cell 121 of the transfer destination by using the designated cell number n, so that the tape cartridge 610 is transferred from the transfer origin to the transfer destination. As a result, the cell 121 of the access cell number N, in which the tape cartridge 610 targeted for access currently being accessed is desired to be stored, is emptied.

In the present embodiment, the read write execution section 730 is equivalent to an example of the transfer control section according to the basic aspect described above. Further, the processing in step S342 is equivalent to an example of the operation of the transfer control section according to the basic aspect.

Further, for the correspondence recorded in the correspondence table 701, the following update is executed (step S343).

In this step S343, the volume number recorded in the volume-number storage field 701a corresponding to the access cell number N is moved to the volume-number storage field 701a corresponding to the designated cell number n in the correspondence table 701.

In the processing of this step S343, in the correspondence table 701, the volume-number storage field 701a corresponding to the access cell number N in which the tape cartridge 610 targeted for access currently being accessed is desired to be stored, is emptied.

When YES is obtained in step S341, this read write processing ends upon completion of the update of the correspondence in step S343.

On the other hand, when it is determined that the access cell number N and the designated cell number n are equal to each other in step S341 (NO in step S341), step S342 and step S343 are omitted, and this swap processing is completed.

When the read write processing and the swap processing described above are completed, the command conversion device 700 informs the host device 400 of this effect. Then, the host device 400 issues the UNLOAD. Upon receipt of this UNLOAD, the UNLOAD execution section 740 of the command conversion device 700 executes UNLOAD processing.

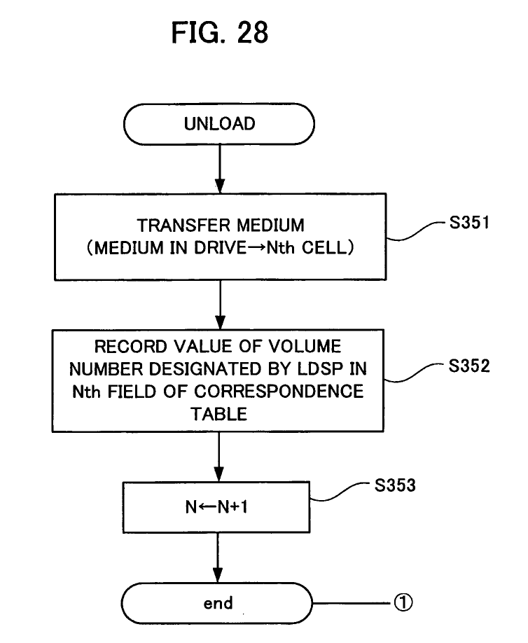

FIG. 28 is a flowchart that illustrates the UNLOAD processing in the fourth embodiment.

In the UNLOAD processing, at first, the UNLOAD execution section 740 reads the access cell number N from the variable table 702 in FIG. 22B.

Subsequently, the UNLOAD execution section 740 issues a command that designates the cell 121 by using the access cell number N, thereby causing transfer of the tape cartridge 610 from the tape drive 130 to the designated cell 121 (step S351). Subsequently, the accessor 140 stores the tape cartridge 610 targeted for access in the cell 121 of the access cell number N according to the command.

When the tape cartridge 610 targeted for access has been originally stored in the cell 121 of the access cell number N, this step S35 is merely a process of returning the tape cartridge 610 targeted for access to the original cell 121.

On the other hand, when the tape cartridge 610 targeted for access has been stored in the cell 121 other than the cell 121 of the access cell number N, this step S351 is a process of storing the tape cartridge 610 targeted for access in the correct cell 121.

Next, the UNLOAD execution section 740 performs the following update for the correspondence in the correspondence table 701 (step S352).

In this step S352, the access volume number V1 is recorded in the volume-number storage field 701a corresponding to the access cell number N of the correspondence table 701.

When there is no interchange and the access volume number V1 has been already recorded in the volume-number storage field 701a corresponding to the access cell number N of the correspondence table 701, this step S352 is merely an overwriting process. On the other hand, when there is an interchange, the volume-number storage field 701a corresponding to the access cell number N of the correspondence table 701 has been emptied by the processing of step S343 in FIG. 27. In this case, this step S352 is a process of recording the access volume number V1 in the correct volume-number storage field 701a corresponding to the access cell number N.

In the present embodiment, through the update of step S343 in FIG. 27 and the update of step S352 in FIG. 28, the correspondence between the volume number and the cell number for the tape cartridge 610 of the access volume number V1 is corrected to result in the proper correspondence.

When the processing in step S352 is completed, the UNLOAD execution section 740 adds “1” to the access cell number N read in step S351, and writes the access cell number N after the addition over the storage field 702a of the access cell number N (step S353). Subsequently, the UNLOAD execution section 540 ends this UNLOAD processing upon completion of this overwriting.

The UNLOAD execution section 740 performing the UNLOAD processing described above is equivalent to an example of the medium storage control section in the basic aspect.

For the above-described aspect, there is a preferable aspect as follows. In this preferable aspect, the storage medium includes a storage part where information is stored and a housing where the storage part is housed, and medium information for identifying the storage medium is recorded on a surface of the housing. In addition, the library device includes a reader that reads the medium information from the surface of the housing of the storage medium. The library control device further includes a correspondence acquisition section, a correspondence recording section and a correspondence updating section. The correspondence acquisition section orders the library device to read the medium information by the reader so as to cause the reader to read the medium information, and thereby acquires a correspondence between the storage medium represented by the read medium information and a storage location where the storage medium is stored. The correspondence recording section records the correspondence acquired by the correspondence acquisition section. The correspondence updating section updates the correspondence recorded by the correspondence recording section, when transfer of the storage medium is ordered by the transfer control section. The loading control section indicates, to the library device, the storage location represented by the correspondence for the storage medium designated by the medium-designating information, among correspondences recorded by the correspondence recording section.

According to this preferable aspect, the correspondence is easily obtained by reading of the medium information by the reader. Moreover, the loading control section indicates the storage location by using the correspondence, for the storage medium designated by the medium-designating information. Thus, efficiency of the processing in the loading control section is improved.

In the present embodiment, the tape cartridge 610 illustrated in FIG. 24 is equivalent to an example of the storage medium in this preferable aspect. Further, in the present embodiment, the shell 612 illustrated in FIG. 24 is equivalent to an example of the housing on whose surface “medium information for identifying the storage medium is recorded” in this preferable aspect. Furthermore, in the present embodiment, the bar code reader 620 illustrated in FIG. 23 is equivalent to an example of the reader in this preferable aspect.

Still furthermore, in the present embodiment, the initial setting section 710 is equivalent to an example of the correspondence acquisition section and the correspondence recording section in this preferable aspect. Moreover, the processing in step S312 in the initial setting processing illustrated in FIG. 25 is equivalent to the operation of the example of the correspondence acquisition section and the second correspondence recording section in this preferable aspect.

Further, in the present embodiment, the read write execution section 730 and the UNLOAD execution section 740 combined are equivalent to an example of the second correspondence updating section in this preferable aspect. Furthermore, the processing in step S343 illustrated in FIG. 27 and the processing in step S352 illustrated in FIG. 28 combined are equivalent to an example of the operation of the second correspondence updating section in this preferable aspect.

Still further, in the present embodiment, the LDSP execution section 720 is equivalent to an example of the loading control section in this preferable aspect. Moreover, the LDSP processing illustrated in FIG. 27 is equivalent to an example of the operation of the loading control section in this preferable aspect.

Now, although slightly overlapping the description provided above with reference to each processing of FIG. 24 through FIG. 28, a process up to completion of automatic correction of the interchange in the present embodiment will be described by using a specific example of the interchange.

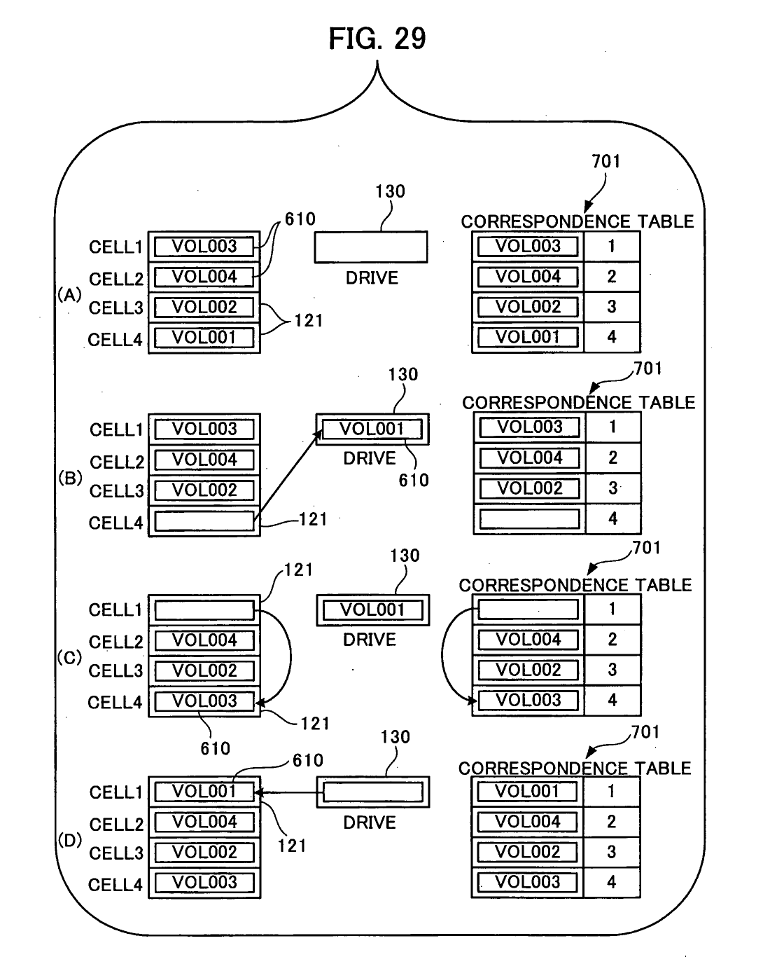

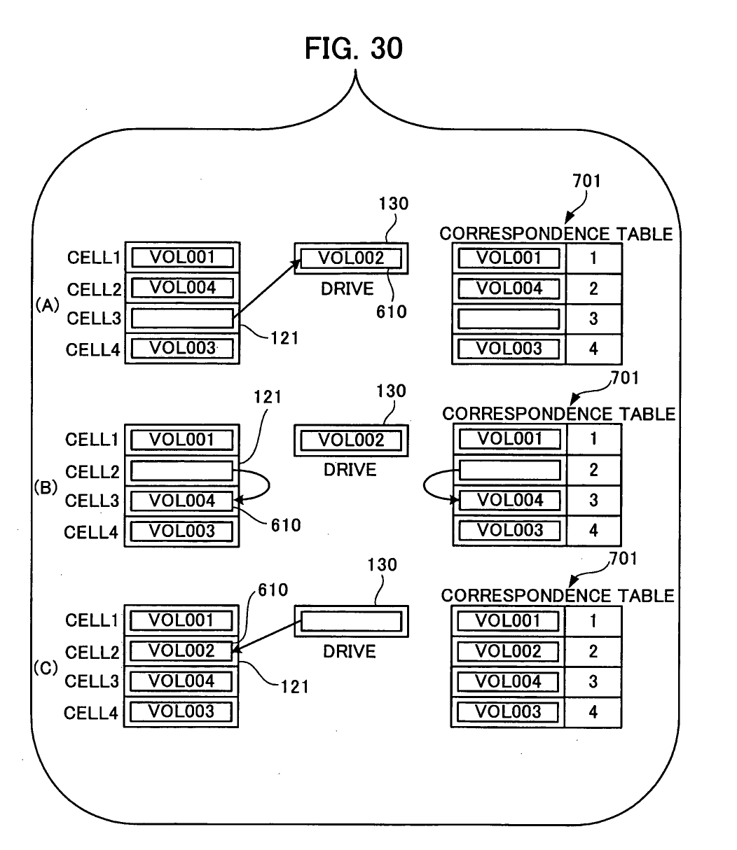

FIG. 29 is a diagram that illustrates the first half of the process up to the completion of the automatic correction of the interchange. FIG. 30 is a diagram that illustrates the latter half of this process.

FIG. 29 and FIG. 30 illustrate a state in which interchanges that will be described below are automatically corrected for four tape cartridges 610 having the volume numbers “VOL001” through “VOL004” stored in four cells 121 having the cell numbers “1” through “4”. In the present embodiment as well, the interchange is corrected every time access is made. For this reason, each of FIG. 29 and FIG. 30 also illustrates the tape drive 130 that accesses the tape cartridge 610. Further, in the present embodiment, the correspondence between the volume number and the cell number is record in the correspondence table 701, and the correction is executed based on the recorded correspondence. For this reason, each of FIG. 29 and FIG. 30 also illustrates the correspondence table 701.

First, in this example, as illustrated in Part (A) in FIG. 29, all of the four tape cartridges 610 having the volume numbers “VOL001” through “VOL004” are stored in wrong cells 121 among the four cells 121 having the cell numbers “1” through “4”.

In the initial setting processing described above, as illustrated in this Part (A), for the state of being interchanged as it is, the correspondence between the volume number and the cell number is recorded in the correspondence table 701 for all of the four tape cartridges 610 in such an interchange state.

Subsequently, in response to issue of the first LDSP, the LDSP processing in FIG. 26 is executed. To the first LDSP, “VOL001” is attached as the access volume number V1.

In this first LDSP processing, through the processing of step S322 to S325 in FIG. 26, the cell number “4” corresponding to the current access volume number V1 “VOL001” is found in the correspondence table 701. Subsequently, as illustrated in Part (B) in FIG. 29, the tape cartridge 610 of the access volume number V1 “VOL001” stored in the cell of the found cell number “4” is loaded into the tape drive 130.

Further, the read write processing in FIG. 26 and the swap processing in FIG. 27 are executed. Subsequently, as illustrated in Part (C) of FIG. 29, in the swap processing, the tape cartridge 610 of the volume number “VOL003” in the cell 121 of the access cell number “1” is transferred to the cell 121 of the cell number “4”.

Further, as illustrated in Part (C), in the swap processing, the volume number “VOL003” corresponding to access cell number “1” is moved to the volume-number storage field 701a corresponding to the cell number “4” in the correspondence table 701.

Subsequently, the UNLOAD processing in FIG. 28 is executed, and as illustrated in Part (D) in FIG. 29, the tape cartridge 610 of the access volume number V1 “VOL001” is returned to the cell 121 of the access cell number “1”.

Further, in this UNLOAD processing, as illustrated in Part (D), the access volume number V1 “VOL001” is stored in the volume-number storage field 701a corresponding to the access cell number “1” in the correspondence table 701. In this example, at this stage, the interchange is corrected for the tape cartridge 610 of the volume number “VOL001”.

In the second LDSP processing executed subsequently, the cell number “3” corresponding to the current access volume number V1 “VOL002” is found in the correspondence table 701. Subsequently, as illustrated in Part (A) of FIG. 30, the tape cartridge 610 of the access volume number V1 “VOL002” stored in the cell of the found cell number “3” is loaded into the tape drive 130.

Next, the read write processing and the swap processing are executed again.

Subsequently, as illustrated in Part (B) in FIG. 30, in the swap processing, the tape cartridge 610 of the volume number “VOL004” in the cell 121 of the access cell number “2” is transferred to the cell 121 of the cell number “3”.

Further, as illustrated in this Part (B), in the swap processing, the volume number “VOL004” corresponding to the access cell number “2” is moved to the volume-number storage field 701a corresponding to the cell number “3” in the correspondence table 701.

Subsequently, the UNLOAD processing is executed again, and as illustrated in Part (C) in FIG. 30, the tape cartridge 610 of the access volume number V1 “VOL002” is returned to the cell 121 of the access cell number “2”. Further, as illustrated in Part (C), the access volume number V1 “VOL002” is recorded in the volume-number storage field 701a corresponding to the access cell number “2” in the correspondence table 701. In this example, at this stage, the interchange is corrected for the tape cartridge 610 of the volume number “VOL002”.

Although the description of the third LDSP processing executed subsequently and the like will be omitted, in this example, at the time of executing the third LDSP processing, read write processing, swap processing and UNLOAD processing, the remaining interchange is corrected.

As described above, in the library system 800 of the present embodiment as well, every time the tape cartridge 610 is accessed, the interchange is automatically corrected. Further, in the present embodiment, in the initial setting processing, the correspondence between the volume number and the cell number is recorded in the correspondence table 701 for all the tape cartridges 610. Furthermore, in the present embodiment, the correspondence recorded in the correspondence table 701 is used for the access of the tape cartridge 110 and the correction of the interchange and thus, efficiency of the processing is improved.

Incidentally, in the above description, as an example of the library device according to the basic aspect described above, the tape library device that employs the cartridge tape as a storage medium is used, but the library device in the basic aspect is not limited to this example. The library device according to the basic aspect described above may be, for example, a device that uses a Digital Versatile Disc (DVD) or a Magneto Optical (MO) disk as a storage medium.

Moreover, in the above description, as an example of the storage-location designating information and the medium-designating information according to the basic aspect described above, the number such as the cell number and the volume number is used. However, the storage-location designating information and the medium-designating information in the basic aspect are not limited to the number. The storage-location designating information and the medium-designating information according to the basic aspect described above may be, for example, a sign such as an alphabet.

Still furthermore, in the above description, as an example of the new storage location of the “storage medium stored in the storage location designated by the storage-location designating information” indicated by the transfer control section according to the basic aspect described above, the cell in which the tape cartridge targeted for access is stored is used. However, the new storage location of the “storage medium stored in the storage location designated by the storage-location designating information” is not limited to this example. For instance, this new storage location may be, a storage location or the like prepared beforehand as a temporary saving destination of such a storage medium.

Moreover, in the above description, as an example of the storage medium and an example of the reader in the preferable aspect in which the reader that reads the medium information recorded on the surface of the storage medium is provided, the storage medium (tape cartridge) to which the bar code label 611 is affixed and the bar code reader 620 are used, respectively. However, the storage medium and the reader in this preferable aspect are not limited to these examples, and may be a storage medium to which a label with Quick Response (QR) code is affixed and a QR code reader, respectively.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A library control device that controls a library device including a transfer mechanism for transferring a storage medium to each of transfer locations including a storage locations of a storage shelf and a loading point of a drive, the library control device comprising:
a designated-information acquisition section that acquires medium-designating information that designates a storage medium for access target in the library device and storage-location designating information that designates a transfer origin for transfer of a storage medium by the transfer mechanism;
a loading control section that at least eventually indicates, to the library device, a storage location of a storage medium designated by the medium-designating information, to cause the storage medium designated by the medium-designating information to be loaded into the drive;
a transfer control section that orders, when the storage location indicated by the loading control section to the library device and a storage location designated by the storage-location designating information are different from each other, while the drive accesses the storage medium designated by the medium-designating information, the library device to transfer a storage medium other than a storage medium designated by the medium-designating information by the transfer mechanism from the storage location designated by the storage-location designating information to a storage location different from the storage location designated by the storage-location designating information, thereby emptying the storage location designated by the storage-location designating information; and
a medium storage control section that orders, when the storage medium designated by the medium-designating information is loaded in the drive and the storage medium is transferred to the storage shelf, the library device to store the storage medium by the transfer mechanism in the storage location designated by the storage-location designating information emptied by the transfer control section.

2. The library control device according to claim 1, wherein the transfer control section orders transfer of the storage medium from the storage location designated by the storage-location designating information to the storage location in which the storage medium accessed by the drive has been stored.

3. The library control device according to claim 1, wherein the loading control section includes:
a storage location indication section that indicates, to the library device, one storage location selected from among a plurality of storage locations of the storage medium, to cause the storage medium to be loaded from the designated storage location into the drive;
a storage information acquisition section that acquires stored-medium information representing the storage medium of the storage location indicated by the storage location indication section; and
a selection section that repeats selection processing for selecting one storage location from among the plurality of storage locations so that the selected storage location is indicated to the library device by the storage location indication section, until the storage medium designated by the medium-designating information and the storage medium represented by the stored-medium information agree with each other, while changing the storage location.

4. The library control device according to claim 3, wherein
the storage medium includes a storage part where information is stored and a housing where the storage part is housed, and medium information for identifying the storage medium is stored in the storage part, and
the storage information acquisition section acquires the medium information stored in the storage part of the storage medium transferred to the drive by indication of the storage location in the storage location indication section, as the stored-medium information via the drive.

5. The library control device according to claim 3, wherein the loading control section further includes:
a correspondence recording section that records a correspondence between the storage medium represented by the stored-medium information acquired by the storage information acquisition section and a storage location where the storage medium is stored;
a correspondence updating section that updates the correspondence recorded by the correspondence recording section, when transfer of the storage medium is ordered by the transfer control section, and
a second selection section that substitutes the selection section serving as a first selection section and selects the storage location represented by the correspondence when the correspondence is already recorded for the storage medium designated by the medium-designating information, so that the selected storage location is indicated to the library device by the storage location indication section.

6. The library control device according to claim 1, wherein the storage medium includes a storage part where information is stored and a housing where the storage part is housed, and medium information for identifying the storage medium is recorded on a surface of the housing,
the library device includes a reader that reads the medium information from the surface of the housing of the storage medium,
the library control device further comprises:
a correspondence acquisition section that orders the library device to read the medium information by the reader so as to cause the reader to read the medium information, and thereby acquires a correspondence between the storage medium represented by the read medium information and a storage location where the storage medium is stored;
a correspondence recording section that records the correspondence acquired by the correspondence acquisition section; and
a correspondence updating section that updates the correspondence recorded by the correspondence recording section, when transfer of the storage medium is ordered by the transfer control section, and
the loading control section indicates, to the library device, the storage location represented by the correspondence for the storage medium designated by the medium-designating information, among correspondences recorded by the correspondence recording section.

7. A library system comprising:
a library device including:
a transfer mechanism for transferring a storage medium to each of transfer locations including a storage locations of a storage shelf and a loading point of a drive; and
a library control device including:
a designated-information acquisition section that acquires medium-designating information that designates a storage medium for access target in the library device and storage-location designating information that designates a transfer origin for transfer of the storage medium by the transfer mechanism;
a loading control section that at least eventually indicates, to the library device, a storage location of a storage medium designated by the medium-designating information, to cause the storage medium designated by the medium-designating information to be loaded into the drive;
a transfer control section that orders, when the storage location indicated by the loading control section to the library device and a storage location designated by the storage-location designating information are different from each other, while the drive accesses the storage medium designated by the medium-designating information, the library device to transfer a storage medium other than a storage medium designated by the medium-designating information by the transfer mechanism from the storage location designated by the storage-location designating information to a storage location different from the storage location designated by the storage-location designating information, thereby emptying the storage location designated by the storage-location designating information; and
a medium storage control section that orders, when the storage medium designated by the medium-designating information is loaded in the drive and the storage medium is transferred to the storage shelf, the library device to store the storage medium by the transfer mechanism in the storage location designated by the storage-location designating information emptied by the transfer control section.
